(19) United States
(12) Patent Application Publication
(10) Pub. No.: US 2008/0143697 A1
(43) Pub. Date: Jun. 19, 2008

(54) DRIVE VOLTAGE CONTROL DEVICE

(76) Inventor: Tomokazu Kojima, Osaka (JP)

Correspondence Address: MCDERMOTT WILL & EMERY LLP, 600 13TH STREET, NW, WASHINGTON, DC, 20005-3096, US

(21) Appl. No.: 11/955,936

(22) Filed: Dec. 13, 2007

(30) Foreign Application Priority Data
Dec. 13, 2006 (JP) 2006-335849
Sep. 18, 2007 (JP) 2007-241009

(51) Int. Cl. G06F 3/038

(52) U.S. Cl. 345/204

(57) ABSTRACT

A buffer generates a load drive voltage by impedance-converting an input signal and outputs the generated load drive voltage to a load circuit. An input level controller controls a voltage of the input signal to be a boost voltage having a potential higher than that of a targeted drive voltage of the load drive voltage during a certain period in an initial stage where the voltage of the input signal is changed, and controls the voltage of the input signal to be the targeted drive voltage during the period other than the certain period in the initial stage of the voltage change.

### BACKGROUND OF THE INVENTION

1. Field of the Invention

The present invention relates to a drive voltage control device for controlling a load drive voltage for driving a load circuit of a liquid crystal panel or the like, more particularly to a technology for realizing a speedy rise of the load drive voltage at such a speed that corresponds to a time period shorter than a time constant decided by a load capacitance and a load resistance.

2. Description of the Related Art

There is known a conventional drive voltage control device capable of achieving the reduction of power consumption and a high speed at the same time by controlling a bias current of an operation amplifier. An other conventional device is an operation amplifier provided with a boost function in order to realize even a higher speed, which is recited in No. 2003-188652 of the Japanese Patent Applications Laid-Open.

Referring to a liquid crystal panel, a drive device which achieves a higher precision and a higher speed is increasingly demanded as a resolution is higher and a screen size is larger. Further, it is requested in the liquid crystal panel that a device size be reduced in order to reduce a frame of the display panel and consumed current be controlled in addition to the demand for responding to the large-size screen.

FIG. 31 shows a conventional liquid crystal panel drive device of the active matrix type. Referring to reference numerals shown in the drawing, 11 denotes a liquid crystal panel in which X×Y number of liquid crystal cells LC are arranged in the two-dimensional matrix shape, 12 denotes a controller, 13 denotes a source driver, 14 denotes a gate driver, and 15 denotes a drive voltage control device. D1-DX denotes X number of data wires extended from the source driver 13 and connected to source electrodes of the liquid crystal cells LC. G1-GY denote Y number of gate wires extended from the gate driver 14 and connected to gate electrodes of the liquid crystal cells LC. COM denotes counter electrodes connected to the respective liquid crystal cells LC. The liquid crystal cell LC includes a switching element such as TFT (thin-film transistor) and a liquid crystal element.

The controller 12 receives a state indication signal STATE which shows the drive of the panel, and then, outputs display data DATA to the source driver 13 and also outputs a scan control signal LINE to the gate driver 14. The liquid crystal elements included in the liquid crystal cells LC receive a targeted drive voltage VH on a high-level side or a targeted drive voltage VL on a low-level side supplied from the drive voltage control device 15 to the counter electrodes COM. The source driver 13 supplies a data signal having a voltage value corresponding to the display data DATA which shows a gradation level outputted from the controller 12 to the data wires D1-DX. The gate driver 14 supplies a gate signal corresponding to the scan control signal LINE outputted from the controller 12 to the gate wires G1-GY. The liquid crystal elements included in the liquid crystal cells LC allow light to be transmitted based on a transmission factor in accordance with a difference between the voltage value of the data signal supplied to the data wires and the voltage value of the targeted drive voltage VH on the high-level side or the targeted drive voltage VL on the low-level side supplied to the counter electrodes.

The targeted drive voltage VH on the high-level side and the targeted drive voltage VL on the low-level side are alternately repeated through constant cycles in the drive voltage control device 15 in order to prevent the burn-in of the liquid crystal element, which is called the alternate current drive system (counter-line inversion drive system).

FIG. 32 shows a general circuit configuration of the conventional drive voltage control device. A1 denotes an operation amplifier, 2 denotes a load circuit which equivalently expresses a liquid crystal panel provided with a load capacitance C_{OUT} and a load resistance R_{OUT}. When a signal having such a waveform that is shown in FIG. 34A is inputted to the operation amplifier A1, such an output waveform that is shown in FIG. 34B is obtained. A load drive voltage V_{OUT} outputted from the operation amplifier A1 is converged to the targeted drive voltage VH on the high-level side, in which case one of a through rate (internal through rate) of the operation amplifier A1 and an external through rate thereof based on a time constant resulting from the load capacitance C_{OUT} and the load resistance R_{OUT} of the load circuit 2, which ever is lower, rate-limits an overall delay time. When the internal through rate of the operation amplifier A1 is set to a substantially high value according to the method recited in No. 2003-188652 of the Japanese Patent Applications Laid-Open mentioned earlier, a system of the drive voltage control device is determined by the external through rate, which saturates the speed.

FIG. 33 shows a constitutional example of a drive voltage control device for generating a drive voltage with respect to counter electrodes which is adopted in a liquid crystal screen of a mobile telephone. The targeted drive voltage VH on the high-level side (for example, 3V) and the targeted drive voltage VL on the low-level side (for example, −3V) to be supplied to the liquid crystal screen are impedance-converted by an operation amplifier A1 on a positive-electrode side and an operation amplifier A3 on a negative-electrode side, respectively, and an output switch Sx is changed over at a predetermined timing, so that a voltage having an amplitude between −3V and +3V is supplied to the liquid crystal screen. Resistances R1 and R2 and capacitances C1 and C2 are provided for the smoothing operation (in order to prevent oscillation). A resistance R_{OUT} and a capacitance C_{OUT} are equivalent models of the liquid crystal panel. FIGS. 35A and 35B show the input and output waveforms. The output switch Sx is operated by a selection signal SEL from a timing controller 3, the positive-electrode-side operation amplifier A1 and the negative-electrode-side operation amplifier A3 are alternately selected, and the targeted drive voltage VH on the high-level side and the targeted drive voltage VL on the low-level side are alternately outputted to an output of a power supply for the counter electrodes.

In the drive voltage control device shown in FIG. 33, a delay is generated in its output when the output switch Sx is operated. At the time, one of the following which is at the lowest level determines the overall delay time:

operation amplifier A1 and capacitance C1;

internal through rate in relation to operation amplifier A3 and capacitance C2; and

external through rate based on time constant decided by capacitance C_{OUT} and load resistance R_{OUT} of load circuit 2.

The liquid crystal panel having a large screen undergoes a large load, wherein it is an important issue to increase the speed of operation in order to improve the resolution. It is possible to increase the through rates of the operation amplifier by applying the gain boost type recited in the Document mentioned earlier (No. 2003-188652) to the operation amplifiers A1 and A3. However, the external through rate of the load circuit 2, which is fixedly set in each of the liquid crystal panels, rate-limits the delay time. Therefore, it is difficult to remove the restrictions of the speed limit. This disadvantage is recited in, for example, “CMOS Analog Circuit Design Technology”, 1998, Pages 76-77.

### SUMMARY OF THE INVENTION

Therefore, a main object of the present invention is to provide a drive voltage control device capable of realizing the speedy rise of a load drive voltage at such a speed that corresponds to a time period shorter than a time constant of a load circuit.

In order to achieve the foregoing object, the present invention is constituted as follows. In the description below, “buffer” corresponds to a broader concept of the operation amplifier described earlier. The buffer includes a source follower of the operation amplifier and the like as far as it can supply the load drive voltage to the load circuit by impedance-converting an input signal.

A drive voltage control device according to the present invention comprises:

a buffer for generating a load drive voltage by impedance-converting an input signal and outputting the generated load drive voltage to a load circuit; and

an input level controller for controlling a voltage of the input signal to be a boost voltage having a potential higher than that of a targeted drive voltage of the load drive voltage during a certain period in an initial stage where the voltage of the input signal is changed and controlling the voltage of the input signal to be the targeted drive voltage during the period other than the certain period in the initial stage of the voltage change.

A load capacitance of the load circuit reduces a speed at which the applied voltage of the load circuit is increased, which is a delay characteristic of the rise of the load drive voltage. Therefore, the input level controller controls to input the boost voltage whose potential is higher than that of the targeted drive voltage to the buffer in the initial stage of the voltage change. Accordingly, the reduction of the voltage increase speed, which results from the load capacitance, is controlled so as to realize the speedy rise of the load drive voltage. The boost voltage is supplied during the predetermined period. Then, the input level controller changes the voltage of the input signal supplied to the buffer from the boost voltage to the ordinary voltage as the load drive voltage is closer to the targeted drive voltage. As a result, when the load drive voltage is converged to the targeted drive voltage, the convergence can be realized at such a high speed that corresponds to a time period shorter than a time constant decided by the capacitance and the resistance of the load circuit.

2) In the constitution in 1), an absolute value of the boost voltage in the initial stage of the voltage change is preferably at least a voltage value of a power supply voltage (VDD) of the buffer. Accordingly, the boost voltage can be high enough, and the time period necessary for the convergence of the load drive voltage to the targeted drive voltage can be largely reduced.

3) In the constitution in 1), the absolute value of the boost voltage in the initial stage of the voltage change is preferably at most the voltage value of the power supply voltage (VDD) of the buffer. Accordingly, a certain level of improvement can be obtained in comparison to the conventional technology, and power consumption can be reduced though the time period for the convergence of the load drive voltage to the targeted drive voltage is slightly extended in comparison to 2).

4) In the constitution in 1), the drive voltage control device preferably further comprises:

a comparator for comparing the targeted drive voltage and the load drive voltage; and

a boost voltage controller for reducing the boost voltage when the load drive voltage is higher than the targeted drive voltage according to a result of the comparison by the comparator, retaining the boost voltage when the load drive voltage is equal to the targeted drive voltage, and increasing the boost voltage when the load drive voltage is lower than the targeted drive voltage. Accordingly, in the case where the load is variable due to some factor, the boost voltage is automatically adjusted based on the measurement of the load drive voltage by the boost voltage controller. As a result, the load drive voltage can be converged to the targeted drive voltage in a stable manner at such a high speed that corresponds to a time period shorter than the time constant.

5) In the constitution in 4), the comparator preferably repeatedly compares the voltages periodically based on a set reference time. Accordingly, the load drive voltage can be surely brought closer to the targeted drive voltage.

6) In the constitution in 4), the boost voltage controller memorizes the boost voltage and the comparator halts the operation thereof in a state where the convergence time is not updated and in a state where the load circuit is not changed.

Accordingly, the automatic adjustment is not implemented whenever unnecessary, which avoids any unnecessary power consumption.

A drive voltage control device according to the present invention comprises:

a buffer comprising an output terminal, the buffer generating a load drive voltage by impedance-converting an input signal and outputting the generated load drive voltage to a load circuit from the output terminal;

a boost power supply for generating a boost voltage having a potential higher than that of a targeted drive voltage of the load drive voltage;

a voltage-increase control switch inserted between the output terminal and the boost power supply; and

a timing controller, wherein

the timing controller makes the voltage-increase control switch conducted to thereby increase the load drive voltage by the boost voltage and supplies the resulting load drive voltage to the load circuit during a certain period in an initial stage where a voltage of the input signal is changed, and makes the voltage-increase control switch non-conducted and supplies the load drive voltage which is not increased by the boost voltage to the load circuit during the period other than the certain period in the initial stage of the voltage change.

In the foregoing constitution, the timing controller switches on the voltage-increase control switch in the initial stage of the voltage change and applies the boost voltage whose potential is higher than that of the targeted drive voltage to the output terminal of the buffer. Accordingly, the reduction of the voltage increase speed, which results from the load capacitance, can be controlled, and the speedy rise of the load drive voltage can be thereby realized. As the load drive voltage is closer to the targeted drive voltage, the timing controller switches off the voltage-increase control switch. As a result, when the load drive voltage is converged to the targeted drive voltage, the convergence can be realized at such a high speed that corresponds to a time period shorter than the time constant decided by the capacitance and the resistance of the load circuit.

A drive voltage control device according to the present invention comprises:

a buffer comprising an output terminal, the buffer generating a load drive voltage by impedance-converting an input signal and outputting the generated load drive voltage to a load circuit from the output terminal;

a boost power supply for generating a boost voltage having a potential higher than that of a targeted drive voltage;

an input selection switch for selecting one of a voltage of the input signal and the boost voltage and inputting the selected voltage to the buffer;

a smoothing capacitor inserted between the output terminal and a ground;

an output control switch inserted between the smoothing capacitor and the load circuit; and

a timing controller, wherein

the timing controller controls the output control switch to thereby make the smoothing capacitor a charging state and further controls the input selection switch to thereby make the buffer output the boost voltage during a certain period in an initial stage where the voltage of the input signal is changed, and the timing controller controls the output control switch to thereby make the smoothing capacitor a discharging state and further controls the input selection switch to thereby make the buffer output the input signal during the period other than the certain period in the initial stage of the voltage change.

In the foregoing constitution, the timing controller switches off the output control switch and further makes the boost voltage whose potential is higher than that of the targeted drive voltage selected via the input selection switch in the initial stage of the voltage change. Accordingly, the smoothing capacitor is charged with the boost voltage. Then, the timing controller switches on the output control switch in accordance with, for example, a display timing, and the boost voltage whose potential is higher than that of the targeted drive voltage from the smoothing circuit is thereby applied to the load circuit. As a result, the reduction of the voltage increase speed, which results from the load capacitance, is controlled, and the rise of the load drive voltage can be thereby sped up. As the load drive voltage is closer to the targeted drive voltage, the timing controller changes over the input selection switch so that the input of the input signal is selected. Therefore, the convergence of the load drive voltage to the targeted drive voltage can be realized at such a high speed that corresponds to a time period shorter than the time constant decided by the capacitance and the resistance of the load circuit.

A drive voltage control device according to the present invention comprises:

a first buffer for generating a load drive voltage to be supplied to a load circuit by impedance-converting an input signal;

a second buffer for generating a boost voltage having a potential higher than that of a targeted drive voltage of the load drive voltage;

an output selection switch comprising an output terminal, the output selection switch selecting one of outputs of the first and second buffers and outputting the selected output from the output terminal to the load circuit;

a smoothing capacitor inserted between the output terminal and a ground;

an output control switch inserted between the smoothing capacitor and the load circuit; and

a timing controller, wherein

the timing controller controls the output control switch to thereby make the smoothing capacitor a charging state and sets the output selection switch so as to select the output of the second buffer during a certain period in an initial stage where a voltage of the input signal is changed, and the timing controller further controls the output control switch to thereby make the smoothing capacitor a discharging state and sets the output selection switch so as to select the output of the first buffer during the period other than the certain period in the initial stage of the voltage change.

In the foregoing constitution, the timing controller switches off the output control switch in the initial stage of the voltage change and makes the output selection switch select the boost voltage whose potential is higher than that of the targeted drive voltage outputted from the second buffer. Accordingly, the smoothing capacitor is charged with the boost voltage. Then, the timing controller switches on the output control switch in accordance with the display timing or the like, and the boost voltage whose potential is higher than that of the targeted drive voltage from the smoothing capacitor is thereby applied to the load circuit. Accordingly, the reduction of the voltage increase speed, which results from the load capacitance, is controlled, and the rise of the load drive voltage is thereby sped up. As the load drive voltage is closer to the targeted drive voltage, the timing controller changes over the output selection switch so that the output of the input signal outputted from the first buffer is selected. Therefore, the convergence of the load drive voltage to the targeted drive voltage can be realized at such a high speed that corresponds to the time period shorter than the time constant decided by the capacitance and the resistance of the load circuit.

10) The timing controller preferably halts the operation of the second buffer when the output selection switch is set so that the output of the first buffer is selected, and halts the operation of the first buffer when the output selection switch is set so that the output of the second buffer is selected. Accordingly, the operation of one of the buffers whose output is not selected is halted, which reduces the power consumption.

11) A drive voltage control device according to the present invention comprises:

a first buffer comprising a first output terminal, the first buffer generating a load drive voltage to be supplied to a load circuit by impedance-converting an input signal and outputting the generated load drive voltage from the first output terminal;

a second buffer comprising a second output terminal, the second buffer generating a boost voltage having a potential higher than that of a targeted drive voltage of the load drive voltage and outputting the generated boost voltage from the second output terminal;

a smoothing capacitor inserted between a connecting point between the first and second terminals, and a ground;

an output control switch inserted between the smoothing capacitor and the load circuit; and

a timing controller, wherein

the timing controller controls the output control switch to thereby make the smoothing capacitor a charging state and sets the first buffer to a operation-halt state and the second buffer to an operable state during a certain period in an initial stage where a voltage of the input signal is changed, and the timing controller further controls the output control switch to thereby make the smoothing capacitor a discharging state and sets the first buffer to the operable state and the second buffer to the operation-halt state during the period other than the certain period in the initial stage of the voltage change.

In the foregoing constitution, the timing controller switches off the output control switch in the initial stage of the voltage change, and makes the second buffer operate and halts the operation of the first buffer. Accordingly, the smoothing capacitor is charged with the boost voltage. When the timing controller switches on the output control switch in accordance with the display timing or the like, the boost voltage whose potential is higher than that of the targeted drive voltage is applied from the smoothing capacitor to the load circuit. Accordingly, the reduction of the voltage increase speed, which results from the load capacitance, is controlled, and the speed at which load drive voltage rises is thereby increased. As the load drive voltage is closer to the targeted drive voltage, the timing controller makes the first buffer operate and halts the operation of the second buffer. Therefore, when the load drive voltage is converged to the targeted drive voltage, the convergence can be realized at such a high speed that corresponds to a time period shorter than the time constant decided by the capacitance and the resistance of the load circuit. In addition to that, the operation of one of the buffers which is not selected is halted, which results in the reduction of the power consumption.

12) A drive voltage control device according to the present invention comprises:

a buffer comprising an output terminal, the buffer generating a load drive voltage by impedance-converting an input signal and outputting the generated load drive voltage from the output terminal to a load circuit;

a boost power supply for generating a boost voltage having a potential higher than that of a targeted drive voltage of the load drive voltage;

a timing control switch and an output control switch serially inserted between the output terminal and the load circuit;

a voltage-increase control switch inserted between a connecting point between the timing control switch and the output control switch, and the boost power supply;

a smoothing capacitor inserted between the connecting point between the timing control switch and the output control switch, and a ground; and

a timing controller, wherein

the timing controller switches off the timing control switch and switches on the output control switch and further sets the voltage-increase control switch to the ON state during a certain period in an initial stage where a voltage of the input signal is changed, and then, the timing controller switches off the voltage-increase control switch and thereafter switches on the timing control switch.

In the foregoing constitution, the timing controller switches off the timing control switch and switches on the output control switch, and then, turns on the voltage-increase control switch in the initial stage of the voltage change, so that the smoothing capacitor is charged with the boost voltage whose potential is higher than that of the targeted drive voltage. Accordingly, the boost voltage of the smoothing capacitor is applied to the load circuit. Therefore, the reduction of the voltage increase speed, which results from the load capacitance, is controlled, and the speed at which the load drive voltage rises is thereby increased. As the load drive voltage is closer to the targeted drive voltage, the timing controller switches off the voltage-increase control switch and switches on the timing control switch so that the output of the buffer is selected. As a result, when the load drive voltage is converged to the targeted drive voltage, the convergence can be realized at such a high speed that corresponds to a time period shorter than the time constant decided by the capacitance and the resistance of the load circuit.

13) A drive voltage control device according to the present invention comprises:

a buffer comprising an output terminal, the buffer generating a load drive voltage by impedance-converting an input signal and outputting the generated load drive voltage from the output terminal to a load circuit;

a boost power supply for generating a boost voltage having a potential higher than that of a targeted drive voltage of the load drive voltage;

a smoothing capacitor inserted between the output terminal and a ground;

a voltage-increase control switch inserted between the output terminal and the boost power supply;

an output control switch inserted between the smoothing capacitor and the load circuit; and

a timing controller, wherein

the timing controller switches off the output control switch and switches on the voltage-increase control switch, and then, sets the output of the buffer to a high-impedance state during a certain period in an initial stage where a voltage of the input signal is changed, and the timing controller further switches on the output control switch and switches off the voltage-increase control switch, and then, releases the buffer from the high-impedance state so that the buffer is operable during the period other than the certain period in the initial stage of the voltage change.

The foregoing constitution is characterized in that the timing control switch for the output terminal of the buffer is omitted, and the operation of the buffer is halted instead in the constitution recited in 12). According to the constitution, the timing controller switches off the output control switch, sets the output of the buffer to the high-impedance state and then switches on the voltage-increase control switch in the initial stage of the voltage change, so that the smoothing capacitor is charged with the boost voltage whose potential is higher than that of the targeted drive voltage. As the charged voltage is closer to the targeted drive voltage, the timing controller switches off the voltage-increase control switch and switches on the output control switch, so that the boost voltage of the smoothing capacitor is applied to the load circuit. Therefore, the reduction of the voltage increase speed, which results from the load capacitance, is controlled, and the rise of the load drive voltage is thereby accelerated. Further, in the present constitution wherein the timing controller makes the buffer operate, the convergence of the load drive voltage to the targeted drive voltage can be realized at such a high speed that corresponds to a time period shorter than the time constant decided by the capacitance and the resistance of the load circuit.

14) A drive voltage control device according to the present invention comprises:

a buffer comprising an inversion input terminal and an output terminal, the buffer generating a load drive voltage by impedance-converting an input signal and outputting the generated load drive voltage from the output terminal to a load circuit;

a smoothing capacitor inserted between the output terminal and a ground;

a feedback control switch for controlling feedback of the buffer by switching between a state where the inversion input terminal is short-circuited with respect to the ground and a state where the inversion output terminal is short-circuited with respect to the output terminal;

an output control switch inserted between the smoothing capacitor and the load circuit; and

a timing controller for switching on and off the output control switch, wherein

the timing controller controls the feedback control switch so that the inversion input terminal is short-circuited with respect to the ground when the output control switch is in the OFF state to thereby make the buffer operate as a comparator and output a power-supply voltage level during a certain period, and the timing controller further controls the feedback control switch so that the inversion input terminal is short-circuited with respect to the output terminal when the output control switch is in the ON state to thereby make the buffer operate as a voltage follower.

In the foregoing constitution, the timing controller controls the feedback control switch when the output control switch is in the OFF state to thereby connect the inversion input terminal of the buffer to the ground in the initial stage of the voltage change. The buffer thereby operating as the comparator outputs the power-supply voltage level, and the smoothing capacitor is thereby speedily charged. Then, the timing controller switches on the output control switch in accordance with the display timing or the like so that the charged voltage of the smoothing capacitor is applied to the load circuit. Accordingly, the reduction of the voltage increasing speed, which results from the load capacitance, is controlled, and the rise of the load drive voltage is thereby accelerated. Then, as the load drive voltage is closer to the targeted drive voltage, the timing controller controls the feedback control switch to thereby make the inversion input terminal of the buffer short-circuited with respect to the output terminal so that the buffer operates as the voltage follower. As a result, when the load drive voltage is converged to the targeted drive voltage, the convergence can be realized at such a high speed that corresponds to the time period shorter than the time constant decided by the capacitance and the resistance of the load circuit.

15) A drive voltage control device according to the present invention comprises:

a buffer comprising an output terminal, the buffer generating a load drive voltage by impedance-converting an input signal and outputting the generated load drive voltage from the output terminal to a load circuit;

a boost power supply for generating a boost voltage having a potential higher than that of a targeted drive voltage of the load drive voltage;

a smoothing capacitor inserted between the output terminal and a ground;

an output control switch inserted between the smoothing capacitor and the load circuit;

a voltage-increase control switch inserted between a connecting point between the output control switch and the load circuit, and the boost power supply;

a comparator; and

a timing controller for timing-controlling the output control switch, wherein

the comparator controls the voltage-increase control switch to be ON when a monitored potential set at the connecting point between the output control switch and the load circuit is below a predetermined reference voltage, and controls the voltage-increase control switch to be OFF when the monitored potential is at least the predetermined reference voltage.

The foregoing constitution is characterized in that the comparator controls ON and OFF of the voltage-increase control switch for applying the high-level boost voltage to the load circuit. When the timing controller switches on the output control switch and the monitored potential is at a low level, the smoothing capacitor is charged with the boost voltage whose potential is higher than that of the targeted drive voltage when the voltage-increase control switch is in the ON state. As the smoothing capacitor is thus charged, the charged voltage is increased. The comparator monitors the charged potential, and the voltage-increase control switch is switched off when the charged potential is at least the reference voltage. According to the constitution, the voltage-increase control switch can be switched off by a more accurate timing in comparison to the constitution wherein the voltage-increase control switch is switched off by the timing controller. Further, the smoothing capacitor is charged with the boost voltage whose potential is higher than that of the targeted drive voltage. Therefore, when the load drive voltage is converged to the targeted drive voltage, the convergence can be realized at such a high speed that corresponds to a time period shorter than the time constant decided by the capacitance and the resistance of the load circuit. Further, the timing of controlling the voltage-increase controls switch is determined based on the actual measurement of the voltage applied to the load circuit, which improves the accuracy of the timing control.

16) A drive voltage control device according to the present invention comprises:

a positive-electrode-side buffer comprising a positive-electrode-side output terminal, the buffer generating a positive-electrode-side load drive voltage by impedance-converting a positive-electrode-side input signal and outputting the generated positive-electrode-side load drive voltage from the positive-electrode-side output terminal to a load circuit;

a positive-electrode-side boost power supply for generating a positive-electrode-side boost voltage higher than the positive-electrode-side load drive voltage;

a positive-electrode-side input selection switch for selecting one of a voltage of the positive-electrode-side input signal and the positive-electrode-side boost voltage and inputting the selected voltage to the positive-electrode-side buffer;

a positive-electrode-side smoothing capacitor inserted between the positive-electrode-side output terminal and a ground;

a negative-electrode-side buffer comprising a negative-electrode-side output terminal, the buffer generating a negative-electrode-side load drive voltage by impedance-converting a negative-electrode-side input signal and outputting the generated negative-electrode-side load drive voltage from the negative-electrode-side output terminal to the load circuit;

a negative-electrode-side boost power supply for generating a negative-electrode-side boost voltage lower than the negative-electrode-side load drive voltage;

a negative-electrode-side input selection switch for selecting one of a voltage of the negative-electrode-side input signal and the negative-electrode-side boost voltage and inputting the selected voltage to the negative-electrode-side buffer;

a negative-electrode-side smoothing capacitor inserted between the negative-electrode-side output terminal and the ground;

an output switch for alternately switching between the output of the positive-electrode-side buffer and the output of the negative-electrode-side buffer; and

a timing controller for switching between the output of the positive-electrode-side buffer and the output of the negative-electrode-side buffer and outputting the selected output to the load circuit, wherein

in the state where the output switch is controlled to select the output of positive-electrode-side buffer, the timing controller controls the positive-electrode-side input selection switch so that the positive-electrode-side input signal is inputted to the positive-electrode-side buffer and controls the negative-electrode-side input selection switch so that the negative-electrode-side boost voltage is inputted to the negative-electrode-side buffer, and, in the state where the output switch is controlled to select the output of negative-electrode-side buffer, the timing controller further controls the negative-electrode-side input selection switch so that the negative-electrode-side input signal is inputted to the negative-electrode-side buffer and controls the positive-electrode-side input selection switch so that the positive-electrode-side boost voltage is inputted to the positive-electrode-side buffer.

In the foregoing constitution, the following effects are exerted.

i) During the period over which the output switch is controlled by the timing controller to select the output of the negative-electrode-side buffer, the positive-electrode-side input selection switch selects the high-level boost voltage on the positive-electrode side, and the positive-electrode-side smoothing capacitor is charged with the selected boost voltage via the positive-electrode-side buffer in advance. At the time, the negative-electrode-side input selection switch selects the input voltage at the ordinary level, and the selected input voltage is inputted to the load circuit via the negative-electrode-side buffer.

ii) During the period over which the output switch is controlled by the timing controller to select the output of the positive-electrode-side buffer, the negative-electrode-side input selection switch selects the low-level boost voltage on the negative-electrode side, which is supplied to the negative-electrode-side smoothing capacitor via the negative-electrode-side buffer. Then, the relevant capacitor is charged with the negative-electrode-side boost voltage in advance. At the time, the positive-electrode-side input selection switch selects the input voltage at the ordinary level, and the selected input voltage is inputted to the load circuit via the positive-electrode-side buffer.

Then, the timing controller alternately switches between the state in i) and the state in ii) by the output switch.

When i) shifts to ii), the positive-electrode-side smoothing capacitor is already fully charged with the positive-electrode-side boost voltage, and the load drive voltage to be supplied to the load circuit speedily converges to the targeted drive voltage. In a similar manner, when ii) shifts to i), the negative-electrode-side smoothing capacitor is already fully charged with the negative-electrode-side boost voltage, and the load drive voltage to be supplied to the load circuit speedily converges to the convergence targeted voltage. The foregoing operation is cyclically repeated, and the voltage waveform for AC-driving the load can be thereby obtained. As a result, the load can be driven at such a high speed that corresponds to a time period shorter than the time constant decided by the load of the liquid crystal panel.

17) A drive voltage control device according to the present invention comprises:

a positive-electrode-side buffer comprising a positive-electrode-side output terminal, the buffer generating a positive-electrode-side load drive voltage by impedance-converting a positive-electrode-side input signal and outputting the generated positive-electrode-side load drive voltage from the positive-electrode-side output terminal to a load circuit;

a positive-electrode-side boost power supply for generating a positive-electrode-side boost voltage higher than the positive-electrode-side load drive voltage;

a positive-electrode-side smoothing capacitor inserted between the output terminal of the positive-electrode-side buffer and a ground;

a positive-electrode-side voltage-increase control switch inserted between the positive-electrode-side output terminal and the positive-electrode-side boost power supply;

a negative-electrode-side buffer comprising a negative-electrode-side output terminal, the buffer generating a negative-electrode-side load drive voltage by impedance-converting a negative-electrode-side input signal and outputting the generated negative-electrode-side load drive voltage from the negative-electrode-side output terminal to the load circuit;

a negative-electrode-side boost power supply for generating a negative-electrode-side boost voltage lower than the negative-electrode-side load drive voltage;

a negative-electrode-side smoothing capacitor inserted between the negative-electrode-side output terminal and the ground;

a negative-electrode-side voltage-increase control switch inserted between the negative-electrode-side output terminal and the negative-electrode-side boost power supply;

an output switch for alternately switching between the output of the positive-electrode-side buffer and the output of the negative-electrode-side buffer; and

a timing controller for switching between the output of the positive-electrode-side buffer and the output of the negative-electrode-side buffer and outputting the selected output to the load circuit, wherein

the timing controller controls the negative-electrode-side voltage-increase control switch to be ON when the output switch is controlled to select the output of the positive-electrode-side buffer, and controls the positive-electrode-side voltage-increase control switch to be ON when the output switch is controlled to select the output of the negative-electrode-side buffer.

The foregoing constitution exerts the following effects.

i) During the period over which the output switch is controlled by the timing controller to select the output of the negative-electrode-side buffer, the negative-electrode-side smoothing capacitor is already fully charged with the negative-electrode-side boost voltage on the negative side, and the negative-electrode-side buffer inputs the negative-electrode-side input signal to the load circuit in the state where the voltage is stable. Then, the positive-electrode-side voltage-increase control switch is switched on, which starts the charge of the positive-electrode-side smoothing capacitor with the positive-electrode-side boost voltage on the high-level side.

ii) During the period over which the output switch is controlled by the timing controller to select the output of the positive-electrode-side buffer, the positive-electrode-side smoothing capacitor is already fully charged with the positive-electrode-side boost voltage, and the positive-electrode-side buffer inputs the positive-electrode-side input signal to the load circuit in the state where the voltage is stable. Then, the negative-electrode-side voltage-increase control switch is switched on, which starts the charge of the negative-electrode-side smoothing capacitor with the negative-electrode-side boost voltage on the low-level side.

Then, the timing controller alternately switches between the state in i) and the state in ii) by the output switch.

When i) shifts to ii), the positive-electrode-side smoothing capacitor is already fully charged with the positive-electrode-side boost voltage, and the load drive voltage to be supplied to the load circuit is speedily converged to the convergence targeted voltage. In a similar manner, when ii) shifts to i), the negative-electrode-side smoothing capacitor is already fully charged with the negative-electrode-side boost voltage, and the load drive voltage to be supplied to the load circuit is speedily converged to the convergence targeted voltage. The foregoing operation is cyclically repeated, and the voltage waveform for AC-driving the load can be thereby obtained. As a result, the load can be driven at such a high speed that corresponds to a time period shorter than the time constant decided by the load of the liquid crystal panel.

18) A drive voltage control device according to the present invention comprises:

a positive-electrode-side buffer comprising a positive-electrode-side output terminal, the buffer generating a positive-electrode-side load drive voltage by impedance-converting a positive-electrode-side input signal and outputting the generated positive-electrode-side load drive voltage from the positive-electrode-side output terminal to a load circuit;

a positive-electrode-side boost power supply for generating a positive-electrode-side boost voltage higher than the positive-electrode-side load drive voltage;

a positive-electrode-side smoothing capacitor inserted between the positive-electrode-side output terminal of the positive-electrode-side buffer and a ground;

a negative-electrode-side buffer comprising a negative-electrode-side output terminal, the buffer generating a negative-electrode-side load drive voltage by impedance-converting a negative-electrode-side input signal and outputting the generated negative-electrode-side load drive voltage from the negative-electrode-side output terminal to the load circuit;

a negative-electrode-side boost power supply for generating a negative-electrode-side boost voltage lower than the negative-electrode-side load drive voltage;

a negative-electrode-side smoothing capacitor inserted between the negative-electrode-side output terminal and the ground;

an output switch comprising an output terminal, the output switch alternately switching between the output of the positive-electrode-side buffer and the output of the negative-electrode-side buffer and outputting the selected output from the output terminal to the load circuit;

a timing controller for timing-controlling the output switch;

a positive-electrode-side voltage-increase control switch inserted between the output terminal and the positive-electrode-side boost power supply;

a positive-electrode-side comparator for controlling the positive-electrode-side voltage-increase control switch to be ON when a potential of the positive-electrode-side smoothing capacitor is below a predetermined reference voltage, and controlling the positive-electrode-side voltage-increase control switch to be OFF when the potential of the positive-electrode-side smoothing capacitor is at least the predetermined reference voltage;

a negative-electrode-side voltage-increase control switch inserted between the output terminal and the negative-electrode-side boost power supply; and

a negative-electrode-side comparator for controlling the negative-electrode-side voltage-increase control switch to be ON when a potential of the negative-electrode-side smoothing capacitor is over a predetermined reference voltage, and controlling the negative-electrode-side voltage-increase control switch to be OFF when the potential of the negative-electrode-side smoothing capacitor is at most the predetermined reference voltage.

In the foregoing constitution, in a manner similar to 17), the load can be speedily driven at such a speed that corresponds to a time period shorter than the time constant decided by the load of the liquid crystal panel or the like on both of the positive and negative sides in order to obtain the voltage waveform for AC-driving the load. Further, the voltage-increase control switches are controlled while the voltage to be applied to the load circuit is monitored by the positive-electrode-side comparator and the negative-electrode-side comparator, which improves the accuracy in the timing control.

19) A drive voltage control device according to the present invention comprises:

a positive-electrode-side buffer comprising a positive-electrode-side output terminal, the buffer generating a positive-electrode-side load drive voltage by impedance-converting a positive-electrode-side input signal and outputting the generated positive-electrode-side load drive voltage from the positive-electrode-side output terminal to a load circuit;

a positive-electrode-side boost power supply for generating a positive-electrode-side boost voltage higher than the positive-electrode-side load drive voltage;

a positive-electrode-side smoothing capacitor inserted between the positive-electrode-side output terminal of the positive-electrode-side buffer and a ground;

a negative-electrode-side buffer comprising a negative-electrode-side output terminal, the buffer generating a negative-electrode-side load drive voltage by impedance-converting a negative-electrode-side input signal and outputting the generated negative-electrode-side load drive voltage from the negative-electrode-side output terminal to the load circuit;

a negative-electrode-side boost power supply for generating a negative-electrode-side boost voltage lower than the negative-electrode-side load drive voltage;

a negative-electrode-side smoothing capacitor inserted between the negative-electrode-side output terminal and the ground;

an output switch comprising an output terminal, the output switch alternately switching between the output of the positive-electrode-side buffer and the output of the negative-electrode-side buffer and outputting the selected output from the output terminal to the load circuit;

a positive-electrode-side voltage-increase control switch inserted between the output terminal and the positive-electrode-side boost power supply;

a negative-electrode-side voltage-increase control switch inserted between the output terminal and the negative-electrode-side boost power supply;

a comparator comprising an inversion input terminal and a non-inversion input terminal, the comparator monitoring a potential of the positive-electrode-side smoothing capacitor and a potential of the negative-electrode-side smoothing capacitor;

a timing controller; and

a group of reference potential switches operating in a manner contrary to one another, wherein

the inversion input terminal is connected to a positive-electrode-side reference potential and a negative-electrode-side reference potential via the group of reference potential switches,

the non-inversion input terminal is connected to the output terminal,

in a state where the positive-electrode-side reference potential is inputted to the inversion input terminal via the group of reference potential switches, the comparator controls the positive-electrode-side voltage-increase control switch to be ON when a first applied voltage inputted to the comparator is below the positive-electrode-side reference voltage, and controls the positive-electrode-side voltage-increase control switch to be OFF when the first applied voltage is at least the reference voltage, and, in a state where the negative-electrode-side reference potential is inputted to the inversion input terminal via the group of reference potential switches, the comparator further controls the negative-electrode-side to be ON when a second applied voltage inputted to the comparator is over the negative-electrode-side reference voltage, and controls the negative-electrode-side voltage-increase control switch to be OFF when the second applied voltage is at most the reference voltage, and the timing controller timing-controls the output switch and the group of reference potential switches.

In the foregoing constitution, in a manner similar to 18), the load can be speedily driven at such a high speed that corresponds to a time period shorter than the time constant decided by the load of the liquid crystal panel or the like on both of the positive and negative sides in order to obtain the voltage waveform for AC-driving the load. Further, the comparator which covers the positive and negative sides is used as the comparator for monitoring the voltage applied to the load circuit in order to decide ON and OFF of the voltage-increase control switch so that the timing control can be highly accurate. As a result, the circuit configuration can be simplified.

20) In any of the drive voltage control device comprising the voltage-increase control switch, a low-breakdown-voltage transistor may preferably constitute the voltage-increase control switch, wherein

a clamp element for voltage drop is inserted between the voltage-increase control switch and the boost power supply. Accordingly, the transistor having the breakdown voltage lower than the power supply voltage of the buffer can be used as the voltage-increase control switch. In the transistor having the low breakdown voltage, a resistance generated when the switch is switched on is low, which improves a switching speed.

21) The drive voltage control device may preferably further comprise a switch controller, wherein

the clamp element is a plurality of clamp elements serially connected to each other, and a short-circuit switching element is connected in parallel to each of the plurality of clamp elements, and

the switch controller arbitrarily switches on and off the short-circuit switching elements.

Accordingly, the number of the clamp elements to be operated with respect to the various load circuits having the different loads can be adjusted, and the rise by a voltage to be applied to each of the load circuits can be accelerated at an optimum voltage level.

22) The clamp element is preferably a diode-connected transistor, a transistor biased with respect to a saturation region, a diode or a resistance.

23) In the constitutions in 1)-22), the buffer is preferably an operation amplifier. In the constitutions in 1)-22), the buffer is preferably a source follower. The operation amplifier, which is superior in its voltage accuracy, is more suitable for the convergence toward the targeted drive voltage.

According to the present invention, the load can be speedily driven at such a speed that corresponds to a time period shorter than the time constant decided by the load of the liquid crystal panel, and it can be avoided to complicate the structure of the buffer.

Further, the drive performance of the buffer for storing the charges in the smoothing capacitor can be optimized. As a result, a mounting area of a liquid crystal driver in which the drive voltage control device according to the present invention is provided can be reduced, which reduces the power consumption.

The technology according to the present invention is useful as a drive voltage control device for driving the liquid crystal panel at such a high speed that corresponds to a time period shorter than the time constant decided by the load of the liquid crystal panel. The technology is further advantageous in that the mounting area and the power consumption can be reduced, and can be effectively applied to a drive voltage control device for driving a high-resolution liquid crystal panel having a large screen.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a circuit diagram illustrating a constitution of a drive voltage control device for a liquid crystal panel according to a preferred embodiment 1 of the present invention.

FIGS. 2A-2D are waveform charts illustrating the operation of the rive voltage control device for the liquid crystal panel according to the preferred embodiment 1.

FIG. 3 is a circuit diagram of the drive voltage control device in the case where an operation amplifier is replaced with a source follower circuit according to a modified embodiment of the preferred embodiment 1.

FIG. 4 is a circuit diagram illustrating a constitution of a drive voltage control device for a liquid crystal panel according to a preferred embodiment 2 of the present invention.

FIGS. 5A-5C are waveform charts illustrating the operation of the rive voltage control device for the liquid crystal panel according to the preferred embodiment 2.

FIGS. 6A-6C are waveform charts illustrating the operation of the rive voltage control device according to a modified embodiment 1 of the preferred embodiment 2.

FIG. 7 is a circuit diagram illustrating a constitution of a drive voltage control device according to a modified embodiment 2 of the preferred embodiment 2.

FIG. 8 is a circuit diagram illustrating a constitution of a drive voltage control device for a liquid crystal panel according to a preferred embodiment 3 of the present invention.

FIG. 9 is a flow chart illustrating the operation of a drive voltage control device according to a modified embodiment of the preferred embodiment 3.

FIGS. 10A-10C are waveform charts of the drive voltage control device according to the modified embodiment of the preferred embodiment 3.

FIG. 11 is a circuit diagram illustrating a constitution of the drive voltage control device according to the modified embodiment of the preferred embodiment 3.

FIG. 12 is a circuit diagram illustrating a constitution of a drive voltage control device for a liquid crystal panel according to a preferred embodiment 4 of the present invention.

FIG. 13 is a circuit diagram illustrating a constitution of a drive voltage control device for a liquid crystal panel according to a preferred embodiment 5 of the present invention.

FIG. 14 is a circuit diagram illustrating a constitution of a drive voltage control device for a liquid crystal panel according to a preferred embodiment 6 of the present invention.

FIG. 15 is a circuit diagram illustrating a constitution for a liquid crystal panel according to a modified embodiment of the preferred embodiment 6.

FIG. 16 is a circuit diagram illustrating a constitution of a drive voltage control device for a liquid crystal panel according to a preferred embodiment 7 of the present invention.

FIG. 17 is a circuit diagram illustrating a constitution of a drive voltage control device for a liquid crystal panel according to a preferred embodiment 8 of the present invention.

FIG. 18 is a circuit diagram illustrating a constitution of a drive voltage control device for a liquid crystal panel according to a preferred embodiment 9 of the present invention.

FIG. 19 is a circuit diagram illustrating a constitution of a drive voltage control device for a liquid crystal panel according to a preferred embodiment 10 of the present invention.

FIG. 20 is a circuit diagram illustrating a constitution of a drive voltage control device for a liquid crystal panel according to a preferred embodiment 11 of the present invention.

FIG. 21 is a circuit diagram illustrating a constitution of a drive voltage control device according to a modified embodiment of the preferred embodiment 11.

FIG. 22 is a circuit diagram illustrating a constitution of a drive voltage control device for a liquid crystal panel according to a preferred embodiment 12 of the present invention.

FIG. 23 is a circuit diagram illustrating a constitution of a drive voltage control device according to a modified embodiment of the preferred embodiment 12.

FIG. 24 is a circuit diagram illustrating a constitution of a drive voltage control device for a liquid crystal panel according to a preferred embodiment 13 of the present invention.

FIG. 25 is a circuit diagram illustrating a constitution of a drive voltage control device for a liquid crystal panel according to a preferred embodiment 14 of the present invention.

FIG. 26 is a circuit diagram illustrating a constitution of a drive voltage control device for a liquid crystal panel according to a preferred embodiment 15 of the present invention.

FIG. 27 is a circuit diagram illustrating a constitution of a drive voltage control device for a liquid crystal panel according to a modified embodiment 1 of the preferred embodiment 15.

FIG. 28 is a circuit diagram illustrating a constitution of a drive voltage control device for a liquid crystal panel according to a modified embodiment 2 of the preferred embodiment 15.

FIG. 29 is a circuit diagram illustrating a constitution of a drive voltage control device for a liquid crystal panel according to a modified embodiment 3 of the preferred embodiment 15.

FIGS. 30A-30E show a constitution of a clamp element according to the preferred embodiment 15.

FIG. 31 is a block diagram illustrating a constitution of a liquid crystal panel drive device of the conventional active matrix system.

FIG. 32 is a circuit diagram illustrating a constitution (1) of a drive voltage control device for a liquid crystal panel according to a conventional technology.

FIG. 33 is a circuit diagram illustrating a constitution (2) of the drive voltage control device for the liquid crystal panel according to the conventional technology.

FIGS. 34A-34B are waveform charts (1) illustrating the operation of the drive voltage control device according to the conventional technology.

FIGS. 35A-35B are waveform charts (2) illustrating the operation of the drive voltage control device according to the conventional technology.

### DETAILED DESCRIPTION OF THE INVENTION

Hereinafter, preferred embodiments of a drive voltage control device according to the present invention are described in detail referring to the drawings.

### Preferred Embodiment 1

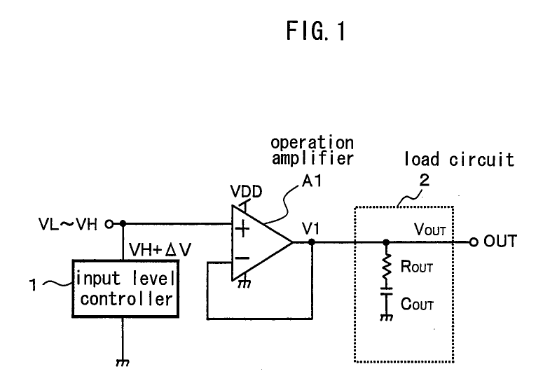

FIG. 1 is a circuit diagram illustrating a constitution of a drive voltage control device for a liquid crystal panel according to a preferred embodiment 1 of the present invention. In FIG. 1, A1 denotes an operation amplifier as a suitable example of a buffer, 1 denotes an input level controller, and 2 denotes a load circuit. An output terminal of the operation amplifier A1 is feedback-connected to an inversion input terminal (−) thereof. The load circuit 2 of the liquid crystal panel comprising a load resistance R_{OUT} and a load capacitance C_{OUT} is connected to the output terminal of the operation amplifier A1. The load circuit 2 is expressed as an equivalent circuit. The input level controller 1 is inserted between a non-inversion input terminal (+) of the operation amplifier A1 and a ground, and controls a level of a voltage to be applied to the non-inversion input terminal (+) of the operation amplifier A1. An output terminal OUT outputs a high-level targeted drive voltage VH having a high voltage and a low-level targeted drive voltage VL having a low voltage with a constant period.

Below is described a convergence time τs. The convergence time τs in the load drive voltage is defined as a time period necessary for 97% of a voltage difference between the targeted drive voltage VH on the high-level side and the targeted drive voltage VL on the low-level side to be reached. For the convenience of the description, the convergence time τs corresponds to 97% of the voltage difference; however, the convergence time τs may be changed depending on the liquid crystal panel or drive method which is adopted.

First, the convergence time τs in the rise of a voltage is described. When an input voltage and an output voltage are both periodically changed to the targeted drive voltage VH on the high-level side from the targeted drive voltage VL on the low-level side (for example, 1 line of liquid crystal=30 microseconds, 1 frame=16 milliseconds), the input voltage is first changed to the targeted drive voltage VH on the high-level side, and a load drive voltage V1 outputted from the operation amplifier A1 gradually approaches the targeted drive voltage VH on the high-level side from the targeted drive voltage VL on the low-level side. At the time, a time period necessary for the output voltage V1 to reach VL+0.97×(VH−VL) is the convergence time τs in the rise of the voltage.

Next, the convergence time τs in the fall of the voltage is described. When the input voltage and the output voltage are both periodically changed to the targeted drive voltage VL on the low-level side from the targeted drive voltage VH on the high-level side (for example, 1 line of liquid crystal=30 microseconds, 1 frame=16 milliseconds), the input voltage is first changed to the targeted drive voltage VL on the low-level side, and the load drive voltage V1 outputted from the operation amplifier A1 gradually approaches the targeted drive voltage VL on the low-level side from the targeted drive voltage VH on the high-level side. At the time, a time period necessary for the output voltage V1 to reach VH−0.97×(VH−VL) is the convergence time τs in the fall of the voltage.

The foregoing description is based on the convergence of ±97%. The convergence of, for example, 95% and 99% can be handled in the same manner when 0.95 and 0.99 are assigned to the formulas in place of 0.97.

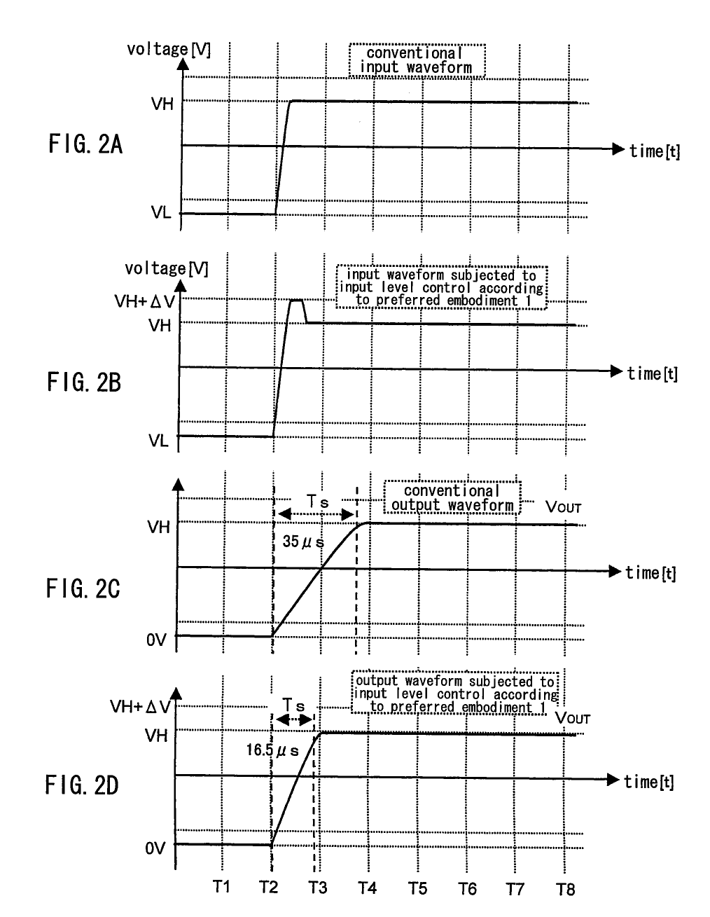

FIG. 2A shows a waveform of the input voltage in the operation amplifier A1 (conventional example), FIG. 2B shows a waveform of the input voltage after the input level is controlled with respect to the operation amplifier A1 (preferred embodiment 1), FIG. 2C shows a waveform of the load drive voltage outputted in response to the input shown in FIG. 2A (conventional example), and FIG. 2D shows a waveform of the load drive voltage outputted in response to the input shown in FIG. 2B (preferred embodiment 1).

As shown in FIG. 2A, the input voltage is converged from the targeted drive voltage VL on the low-level side to the targeted drive voltage VH on the high-level side in an initial stage where the voltage is changed. The time period for the rise of the input voltage is sufficiently shorter than a changing cycle (ΔT=T2−T1 in this case).

As shown in FIG. 2B, the input level controller 1 supplies a boost voltage higher than the targeted drive voltage VH on the high-level side by a voltage ΔV (VH+ΔV) for a certain period of time in the initial stage of the voltage increase from the targeted drive voltage VL on the low-level side, and executes such a level control that the targeted drive voltage VH on the high-level side is continuously supplied. ΔV is the increase amount of the boost voltage. The targeted drive voltage VH on the high-level side is a direct-current voltage decided in accordance with pixel data of the liquid crystal display. As the certain period of time is selected at least a time period corresponding to a unity gain frequency of the operation amplifier A1, more specifically, (VH+ΔV−VL)/(through rate of operation amplifier A1).

In the case where VH=5.0V, ΔV=1.0V, VL=0V, and the through rate of the operation amplifier A1 is 1V/μs, the certain period of time can be 6 μs. The operation at the time is in the initial stage of the voltage change controlled by the drive voltage control device, and the voltage by the input level controller 1 starts to converge toward, not the targeted drive voltage VH on the high-level side, but the boost voltage having a potential higher than that of the targeted drive voltage VH (VH+ΔV). After that, the voltage by the input level controller 1 is reduced to the targeted drive voltage VH on the high-level side. The load drive voltage outputted from the operation amplifier A1 is speedily converged at such a speed that corresponds to a time period shorter than a time constant of the load circuit 2 of the liquid crystal panel, as a result of which the waveform shown in FIG. 2D is obtained. FIG. 2C shows the conventional waveform wherein the input level is not controlled. Thus, the convergence time TS is largely cut down according to the present preferred embodiment.

It is assumed, in this description, that the internal through rate of the operation amplifier A1 (charging time with respect to the phase compensating capacitance of the operation amplifier) is sufficiently higher than the external through rate (charging time from the output of the operation amplifier with respect to the load resistance and capacitance). Therefore, the operation amplifier A1 is designed so that the convergence time τs is decided by the external through rate.

The output waveforms shown in FIGS. 2C and 2D are more specifically described. First, FIG. 2C corresponding to the load drive voltage according to the conventional technology is examined below. It is assumed that a time constant decided by the load of the load circuit 2 (C_{OUT}×R_{OUT}) is τ (=C_{OUT}×R_{OUT}). Then, provided that R_{OUT}=100Ω and C_{OUT}=100 nF, time constant τ=R_{OUT}×C_{OUT}=10 microseconds (μs).

It is assumed that the necessary convergence time TS is a times as long as the time constant τ (τs=a·τ). The equation in relation to the charge and discharge is as in 1).

1−exp(−τs/τ)=1−exp(−a)=0.97 1)

Based on the equation 1), a is obtained by the following formula 2).

a=−LN(1−0.97) 2)

LN is a natural logarithm. In the case of FIG. 2C, a ≈3.5. Therefore, the convergence time τs is approximately 35 μs.

FIG. 2D showing the load drive voltage according to the present preferred embodiment is described below. a is obtained by the following equation 3).

a=−LN(1−0.97×(VH−VL)/(VH+ΔV−VL)) (3)

Showing an example in which numeral values are shown, it is assumed that VH=5.0V, ΔV=1.0V VL=0V. In the case of FIG. 2D, based on the formula 3),

$$\begin{matrix}a = - LN ( 1 - 0.97 \cdot 5 / 6 ) \\ = - LN ( 1 - 0.808 ) \\ = 1.65\end{matrix} \qquad ( 4 )$$

As a result, the convergence time τs is 16.5 μs, which is approximately 47% of 35 τs. Thus, the convergence time τ is largely cut down.

The convergence time τs, for which 3.5τ was necessary in the conventional signal processing, can be reduced to 1.65τ. As a result, the reduced convergence time τs, which is beyond the speed restrictions of the time constant in the case of the drive based on the conventional voltage setting, can be obtained.

In the case where the convergence time τs is other than 97%, any desirable value can be assigned in place of 0.97 in each of the formulas.

Further, as a screen size of the liquid crystal panel is larger and the load resistance R_{OUT} and the load capacitance C_{OUT} are thereby further increased, and further, the constant cycle itself is increased to the double speed or more by the double-speed drive, it becomes difficult to realize the device according to the conventional constitution. In the present preferred embodiment, the increased amount of the boost voltage ΔV can be adjusted so that the constant a is set to a smaller value as shown in 3) though the time constant elements of R_{OUT} and C_{OUT} are increased. As a result, the high-speed convergence in a short period of time beyond the restrictions of the time constant of the liquid crystal panel can be realized.

As described, the drive voltage control device according to the present preferred embodiment is provided with the operation amplifier (buffer) A1 for supplying the load drive voltage resulting from the impedance-converted input signal to the load circuit 2 and the input level controller 2 for supplying the boost voltage whose potential is higher than that of the targeted drive voltage VH on the high-level side (VH+ΔV) as the input voltage with respect to the operation amplifier A1 during the certain period of time in the initial stage of the voltage change and thereafter switching the applied voltage to the targeted drive voltage VH on the high-level side. The impedance conversion can reduce power consumption in such a manner that the output impedance is changed and reduced in comparison to the input impedance.

According to the present preferred embodiment, in the drive voltage control device for driving the liquid crystal panel, the load can be driven at such a high speed that corresponds to the time period shorter than the time constant τ decided by the load of the liquid crystal panel (R_{OUT}×C_{OUT}).

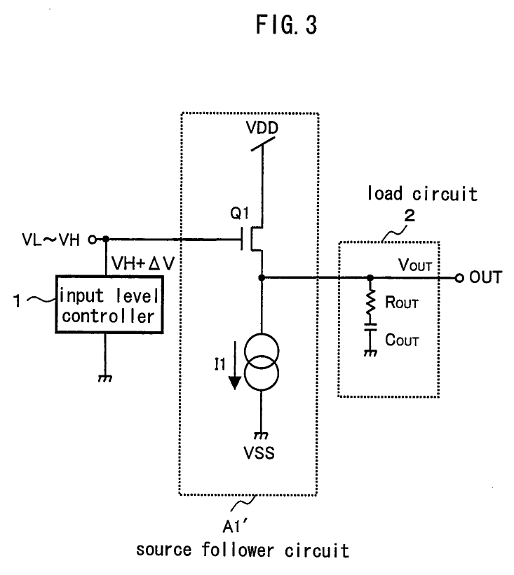

As shown in FIG. 3, the operation amplifier A1 may be replaced with a source follower circuit A1′ for the impedance conversion. In that case, a voltage hither than the before-mentioned input voltage by VT (threshold voltage value) is previously supplied to the input as the input voltage.

### Preferred Embodiment 2

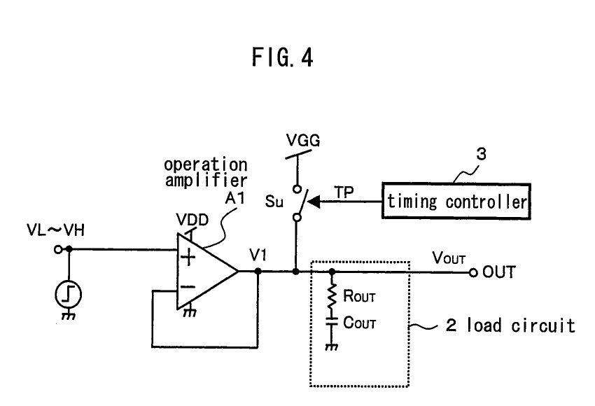

FIG. 4 is a circuit diagram illustrating a constitution of a drive voltage control device for a liquid crystal panel according to a preferred embodiment 2 of the present invention. The input signal is inputted to the non-inversion input terminal (+) of the operation amplifier A1. To the output terminal of the operation amplifier A1 is connected the load circuit 2 of the liquid crystal panel comprising the load resistance R_{OUT} and the load capacitance C_{OUT}. VGG denotes a boost voltage having a potential higher than that of a power supply voltage VDD of the operation amplifier A1. The output terminal of the operation amplifier A1 is connected to a power supply of the boost voltage VGG via a voltage-increase control switch Su. The timing controller 3 switches on and off the voltage-increase control switch Su based on a control signal TP.

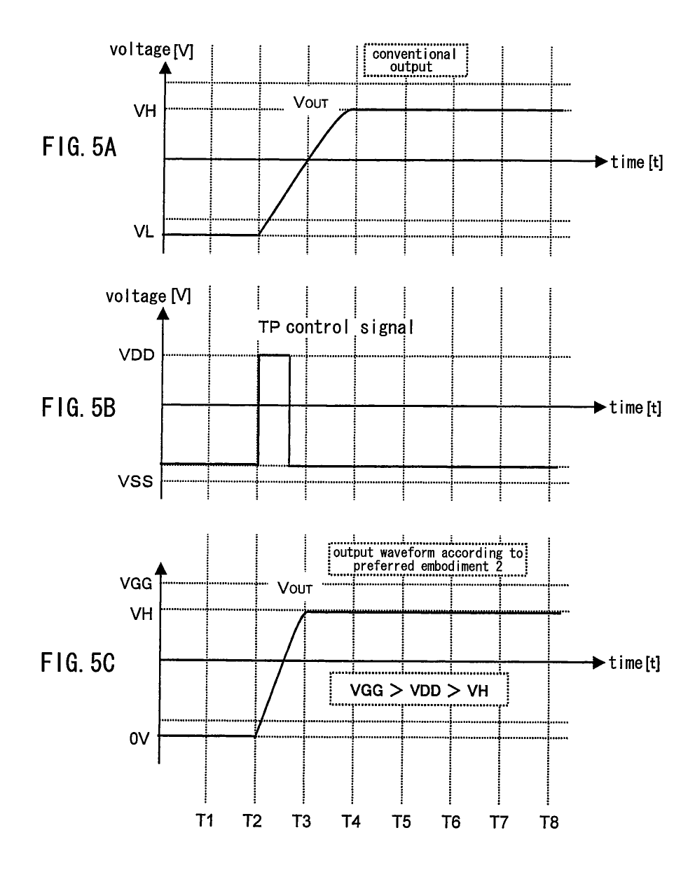

FIGS. 5B and 5c show the foregoing operation. FIG. 5A shows the load drive voltage according to the conventional technology. The timing controller 3 switches on the voltage-increase control switch Su based on the control signal TP, and supplies the boost voltage VGG to an output terminal OUT for a predetermined period of time in the initial stage of the voltage change controlled by the drive voltage control device. Accordingly, the convergence of the load drive voltage V_{OUT} starts toward the boost voltage VGG as its targeted voltage, and the timing controller 3 switches off the voltage-increase control switch Su by inverting the control signal TP when it reaches a level equal to the targeted drive voltage VH on the high-level side. As a result, the load drive voltage V_{OUT} converges toward the targeted drive voltage VH on the high-level side. The convergence can be performed at such a high speed that corresponds to the time period shorter than the time constant decided by the load (C_{OUT}×R_{OUT}) of the liquid crystal panel, which speedily drives the liquid crystal panel.

In the present preferred embodiment, the boost voltage VGG is assigned to the formula 3) in the preferred embodiment 1 in place of (VH+ΔV), the time period when the voltage-increase control switch Su is ON is set to be longer than 1/(unity gain frequency) of the operation amplifier A1 but shorter than the convergence time τs.

Accordingly, in the case where the load resistance R_{OUT} and the load capacitance C_{OUT}. of the liquid crystal panel can be accurately estimated in advance and the convergence time as can be defined, the respective constants are decided so that the formula 3) can be satisfied. As a result, the speed of the rise of the load drive voltage can be freely adjusted beyond the restrictions of the time constant and without any dependence on the panel load.

### Modified Embodiment 1

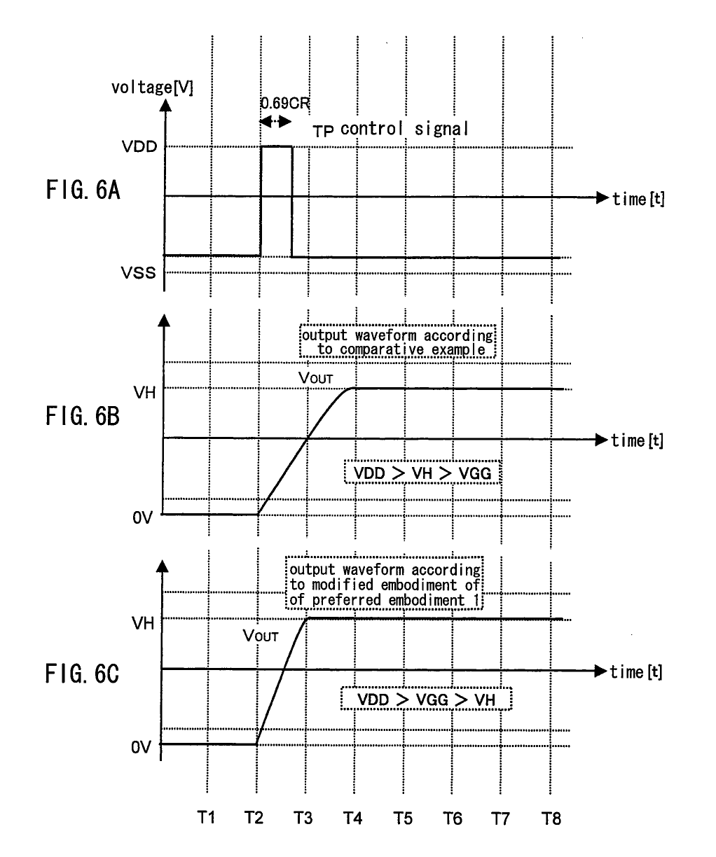

In the preferred embodiments 1 and 2, the boost voltage VGG is higher than the power supply voltage VDD of the operation amplifier A1. However, the boost voltage VGG may be lower than the power supply voltage VDD of the operation amplifier A1, which is characteristic of a modified embodiment 1. In the modified embodiment 1, the power consumption can be reduced in addition to the high-speed drive. The modified embodiment 1 is described referring to FIG. 6.

The power relating to the charge and the discharge can be calculated from an amount of the movement of the charges toward the load capacitance C_{OUT}. The power is calculated provided that the value of the load drive voltage in the initial stage of the voltage change is 0V, and the convergence voltage is the targeted drive voltage VH on the high-level side. In the case where the charge operation is performed by the operation amplifier A1 alone, a charge amount ΔQ is obtained as follows provided that the convergence time is TS.

ΔQ=I_{OUT}×τs (7)

I_{OUT} is the output current of the operation amplifier A1.

Provided that the power supply voltage of the operation amplifier A1 is VDD, the a charge/discharge power P1 is,

P1=VDD×I_{OUT} (8)

Below is examined a case where the boost voltage VGG is supplied to the output terminal OUT for a predetermined period of time t1. Provided that the current flow from the boost voltage VGG to the output is I_{GG},

ΔQ=I_{GG}×t1+I_{OUT}(τs−t1) (9)

Then, the charge/discharge power P1 is,

P1=I_{GG}×VGG×t1/τs+I_{OUT}×VDD×(τs−t1)/τs (10)

The formula 10) shows that the power consumption can be reduced depending on the adjustment of a proportional relationship between the ON time t1 of the boost voltage VGG and a ratio between the power supply voltage VDD of the operation amplifier A1 and the boost voltage VGG.

As described earlier, in the case where the boost voltage VGG is higher than the power supply voltage VDD of the operation amplifier A1, the boost voltage VGG can be set to a high voltage so as to further improve the voltage-increase speed.

### Modified Embodiment 2

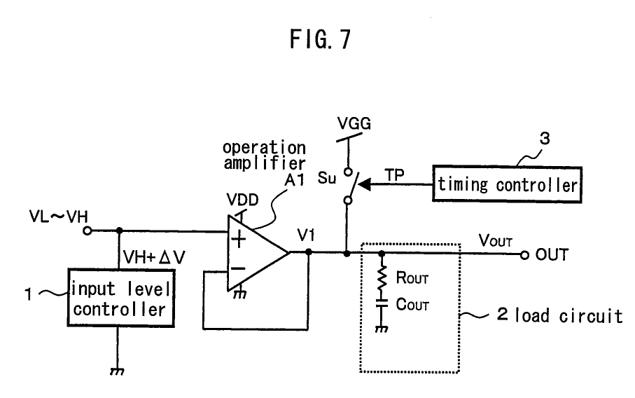

FIG. 7 shows a modified embodiment 2 of the preferred embodiments 1 and 2, wherein the constitution according to the preferred embodiment 1 shown in FIG. 1 and the constitution according to the preferred embodiment 2 shown in FIG. 4 are combined. The constitution according to the modified embodiment 2 is characterized in that the input level controller 1, voltage-increase control switch Su and timing controller 3 are provided.

In the constitution according to the preferred embodiment 1, the input level is controlled by the input level controller 1 so that the convergence at such a high speed that corresponds to the time period shorter than the time constant of the load circuit 2 of the liquid crystal panel can be realized. However, it is actually necessary to set the internal through rate of the operation amplifier A1 to a high level, in other words, it is necessary to prepare a high-speed operation amplifier, which is not easy. In the case of the preferred embodiment 2 shown in FIG. 4, wherein the boost voltage VGG is applied via the voltage-increase control switch Su, the convergence can be achieved at a high speed anyway irrespective of the internal through rate of the operation amplifier A1. On the other hand, when the voltage-increase control switch Su is switched off so that the output of the operation amplifier A1 is selected, switching noise is generated.

In the modified embodiment 2, therefore, the voltage-increase control switch Su is first switched on, and the output of the operation amplifier A1 is selected when the convergence to a level close to the targeted drive voltage VH on the high-level side is obtained. Further, the voltage corresponding to the charges which are supplied and released with respect to the load circuit 2 of the liquid crystal panel is additionally inputted to the operation amplifier A1 by the input level controller 1. As a result, the high-speed convergence can be realized while the waveform distortion and overshoot can be reduced so that the smooth convergence waveform is obtained at the same time.

### Preferred Embodiment 3

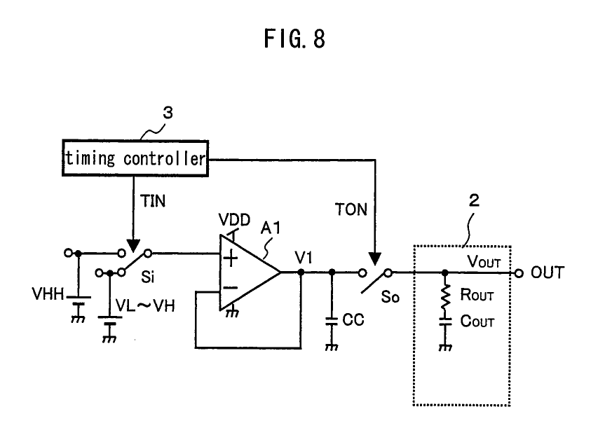

FIG. 8 is a circuit diagram illustrating a constitution of a drive voltage control device for a liquid crystal panel according to a preferred embodiment 3 of the present invention. The same components as those described earlier are provided with the same reference symbols. The direct-current targeted drive voltage VH on the high-level side of the input signal decided by pixel data of the liquid crystal display and a boost voltage VHH higher than the targeted drive voltage VH on the high-level side are selectively inputted to the non-inversion input terminal (+) of the operation amplifier A1 via an input selection switch Si. A smoothing capacitor CC is inserted between the output terminal of the operation amplifier A1 and a ground, and an output control switch So is inserted between the smoothing capacitor CC and the load circuit 2 of the liquid crystal panel. The boost voltage VHH is higher than the targeted drive voltage VH on the high-level side, and a difference there between ΔVHH=(VHH−VH) corresponds to the voltage equal to the supplied charges of the smoothing capacitor CC. The difference ΔVHH is decided based on a ratio between the smoothing capacitor CC and the load capacitance C_{OUT} of the liquid crystal panel. The timing controller 3 switches on and off the input selection switch Si based on a control signal TIN, and switches on and off the output control switch So based on a control signal TON. The output control switch So is controlled based on a timing of the liquid crystal display.

In the state where the output control switch So is OFF, the timing controller 3 controls the input selection switch Si based on the control signal TIN and selects the boost voltage VHH, and then, causes the smoothing capacitor CC to be charged with the boost voltage VHH. Next, the timing controller 3 switches on the output control switch So and applies the boost voltage VHH of the smoothing capacitor CC to the load circuit 2 of the liquid crystal panel. As a result, the load drive voltage V_{OUT} is increased. The load drive voltage V_{OUT} at the time converges to the targeted drive voltage VH on the high-level side at such a high speed that corresponds to the time period shorter than the time constant set based on the load resistance R_{OUT} and the load capacitance C_{OUT} of the load circuit 2 of the liquid crystal panel. The timing controller 3 changes the input selection switch Si when the load drive voltage V_{OUT} has reached the targeted drive voltage VH on the high-level side, and selects the targeted drive voltage VH on the high-level side as the input of the operation amplifier A1. With the internal through rate of the operation amplifier A1 being set to be sufficiently high, the convergence of the load drive voltage V_{OUT} at the time when the targeted drive voltage VH on the high-level side is changed in accordance with the pixel data is based on the time constant set based on the load resistance R_{OUT} and the load capacitance C_{OUT} of the liquid crystal panel.

It is assumed that a targeted drive voltage VH_{—}_{^{t0}}=2V on the high-level side is outputted at a time point, and a targeted drive voltage VH_{—}_{^{t1}}=5V on the high-level side is outputted at a subsequent time point of a liquid crystal display cycle. Further, it is assumed that the load capacitance of the liquid crystal panel C_{OUT}=100 nF, the load resistance R_{OUT}=100Ω, and the smoothing capacitor CC=1 μF. If the through rate of the operation amplifier A1 is sufficiently high, the convergence time TS necessary for the convergence to reach 95% of the targeted drive voltage VH_{—}_{^{t1}}=5.0V on the high-level side is calculated as follows based on the time constants=C_{OUT}×R_{OUT}

τs=3τ=3C_{OUT}×R_{OUT}=30 μs (11)

Below is examined a case where the convergence time τs=20 μs is desired. In order to realize the convergence time of 20 μs, 2τ (τ=10 μs) is necessary. The boost voltage VHH which allows the charge in 2τ up to 95% of the targeted drive voltage VH_{—}_{^{t1}}=5.0V on the high-level side can be decided based on the following formula 12).

ΔVHH=VHH−VH_{—}_{^{t1}} (12)

Based on the formula 12) and the equation 1) described earlier,

$$\begin{matrix}Δ VHH = 0.95 ( {VH\_}_{t 1} - {VH\_}_{t 0} ) / ( 1 - exp ( - 2 ) ) - ( {VH}_{- t 0} - {VH}_{- t 0} ) \\ \approx 0.1 ( {VH}_{- t 1} - {VH}_{- t 0} ) \\ = 0.3 V\end{matrix} \qquad ( 13 )$$

The boost voltage VHH is,

VH_{—}_{^{t1}}+ΔVHH=5.3V (14)

The foregoing voltage is supplied as the boost voltage VHH, so that the voltage change corresponding to 95% of the potential difference (VH_{—}_{^{t1}}−VH_{—}_{^{t0}}) between the boost voltage VHH and the targeted drive voltage VH_{—}_{^{t0}} can be realized in 2τ. Therefore, 2τ is apparently enough as the convergence time τs, for which 3τ was conventionally necessary in the output. When the convergence can be thus accelerated, the time period required for the convergence from the targeted drive voltage VH_t0 on the high-level side to the targeted drive voltage VH t on the high-level side can be reduced in comparison to the time period calculated from the time constant defined by the load resistance and the load capacitance of the liquid crystal panel.

Conversely, here, it is verified if there is not any problem in the charge conservation law of the load capacitance C_{OUT} and the smoothing capacitance CC of the liquid crystal panel. The charge transportation is expressed by the following formula.

VHH=(VH_{—}_{^{t1}}−VH_{—}_{^{t0}})×C_{OUT}/CC+VH_{—}_{^{t1}} (15)

When the voltage equal to or more than the foregoing voltage is applied and supplied from the operation amplifier A1 to the smoothing capacitor CC, the charge conservation law is established.

In this case, the boost voltage VHH=5.3V. Therefore, the voltage convergence is possible as far as the smoothing capacitor CC is supplied with the charges before the high-potential-side voltage is changed from VH_{—}_{^{t0}} to VH_{—}_{^{t1}} though the drive performance of the operation amplifier A1 is low. Further, in the present constitution, the operation amplifier A1 can use the whole time period in the cycle of the liquid crystal drive to supply the charges to the smoothing capacitor CC though the speed is increased, and, thus, the performance of the operation amplifier A1 can be reduced. The operation amplifier A1 whose performance is reduced leads to the reduction of the circuit layout, reduction of the power consumption and improvement of the oscillation stability.

### Modified Embodiment of Preferred Embodiment 3

The targeted drive voltage VH on the high-level side, the targeted drive voltage VL on the low-level side, and convergence time τs are decided depending on the material quality of the liquid crystal panel and driving method. In the case of the liquid crystal panel applied to a television receiver having a large size and a high definition, low-temperature polysilicon is used, wherein the dot inversion drive is often adopted. In that case, the voltage to be applied to common electrodes is constant; however, the positive and negative voltages are alternately applied to the respective common electrodes of the source of the liquid crystal element in such a manner that they are switched based on such a cycle as approximately 2 μs to 5 μs based on the video data, so that the liquid crystal panel is driven. In the case where the liquid crystal panel is thus driven, the technology according to the present invention can be applied to the drive of the source. In the case of the liquid crystal panel having a mid to small size, the frame inversion drive, line inversion drive or N-line inversion drive is often used in the OCB (Optically Compensated Birefringence) liquid crystal and TN (Twisted Nematic) liquid crystal. In that case, the positive and negative voltages are applied for the drive based on the cycle of 16 ms in the frame inversion at the common voltage and based on the cycle of 30-50 μs in the line inversion. Further, the load capacitance is nF—a few hundred F orders, and the AC driving can be speedily realized at such a speed that corresponds to a time period shorter than the time constant when the technology according to the present invention is applied to the high-speed drive of such a load.

Regardless of the drive method and type of the panel material, the panel load may be variable in the case where there is variability in the manufacturing process and there are different manufacturing sites. Referring to problems other than the load, when the drive circuit or a circuit including the drive circuit is mounted in the panel, a parasitic capacitance, a parasitic resistance and a parasitic inductor are generated. Further, the panel load itself is actually a complicated distributed constant model, wherein it is often difficult to obtain an accurate approximation using a simplified model of the capacitance and the resistance.

Therefore, in a modified embodiment of the preferred embodiment 3 is described a constitution capable of automatically adjusting the convergence time Ts and the power in an appropriate manner in the case where the panel load is more or less different to an estimated value, the panel load is variable due to the variability of the panel and any device including the panel generated in the manufacturing process, and the panel and the panel load are different.

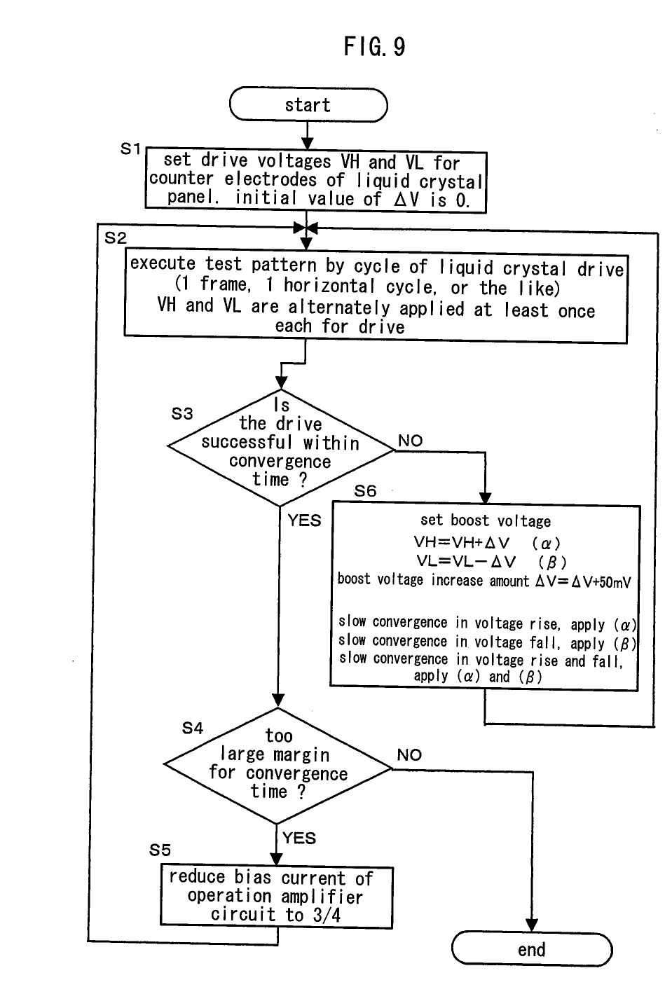

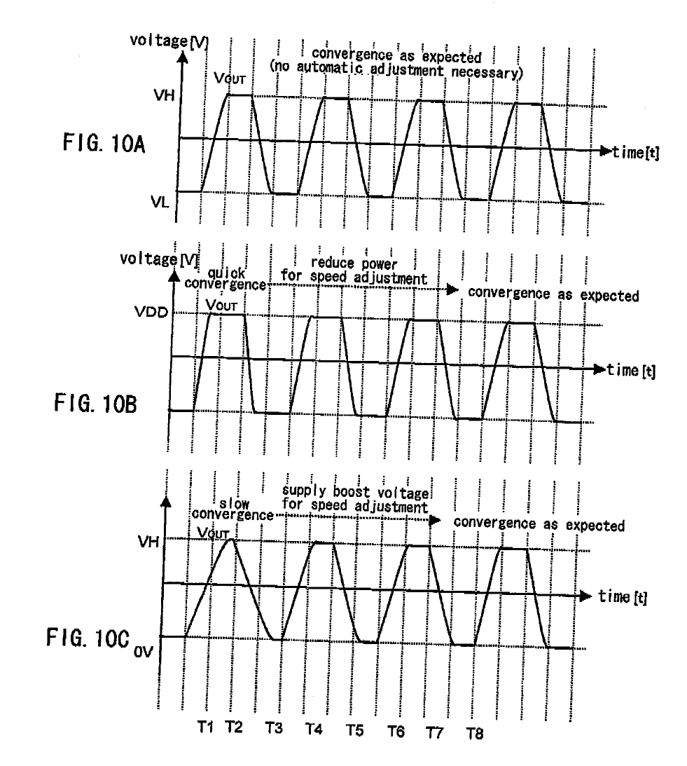

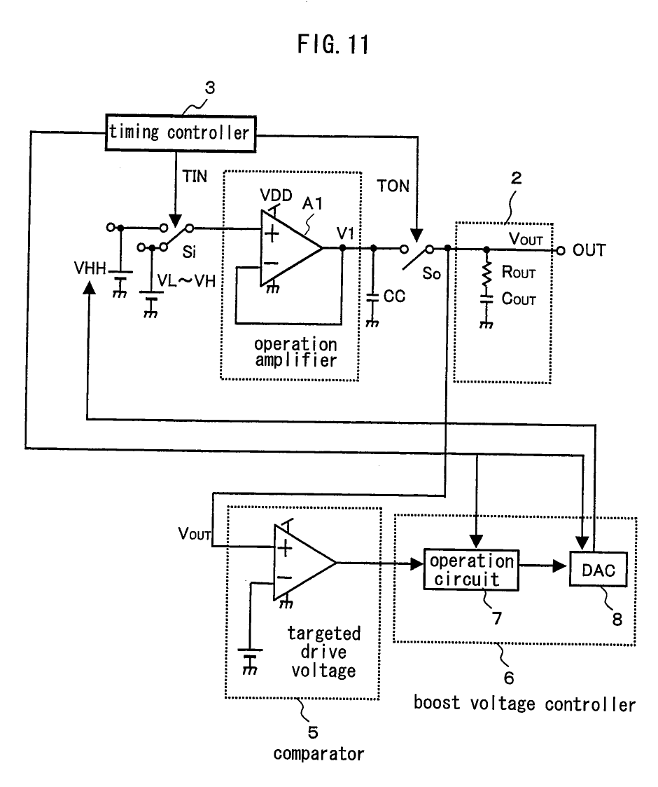

In the case where the load drive voltage is periodically changed due to the result of the formula 15), the automatic control is performed in the preferred embodiment 3. More specifically, though the load capacitance C_{OUT} and the targeted drive voltage VH on the high-level side are different in each liquid crystal panel, the convergence time τs is arranged to be constant (2 μs in the foregoing example) despite these parameters which may be variable. Below is given a description referring to a flow chart shown in FIG. 9 and waveform charts shown in FIGS. 10A-11C.

In Step S1 shown in FIG. 9, respective initial values are set based on the panel material and drive method. Below is given a case where the cycle for changing the positive and negative voltages to be applied to the common electrodes in the line inversion drive is 50 μs. In this case, it is defined that the convergence time τs of the drive circuit is 40 μs, allowing for a margin, and the convergence is realized at 97% of the voltage difference between the targeted drive voltage VH on the high-level side and the targeted drive voltage VL on the low-level side. Further, it is assumed that the drive based on VH=3V, VL=−3V is requested from a viewpoint of the luminance and the contrast of a liquid crystal panel.

From Step S1 to Step S2, the drive circuit is connected to the liquid crystal panel, and the targeted drive voltage VH on the high-level side and the targeted drive voltage VL on the low-level side are alternately applied for the drive so that the waveform is confirmed. In the case where the load capacitance and the load resistance of the liquid crystal panel which are previously estimated are accurate, and the operation amplifier A1 is designed in compliance with the load, the convergence time τs achieves the targeted 40 μs, and the waveform shown in FIG. 10A can be obtained. Then, the judgment in the Step S3 if the drive can be achieved within the convergence time τs shows YES, and the judgment in the Step S4 if the margin of the convergence time τs is too large shows NO. Accordingly, any particular adjustment is not necessary, and the processing is terminated without the automatic adjustment. The actual operation is thereafter started.

Below is given a case where the load capacitance and the load resistance of the liquid crystal panel which are previously estimated are small, and the voltage converges at a speed higher than the assumption. In this case, the performance of the operation amplifier A1 is excessive relative to the load. Then, the judgment in the Step S3 shows YES, and the judgment in the Step S4 shows YES. In Step S5, the bias current of the operation amplifier A1 is reduced to, for example, ¾ in order to adjust the excessive performance thereof. Accordingly, the performance can be reduced by approximately 13.4% since the speed of the operation amplifier A1 is generally in proportion to the square root of the current and the square root of ¾ is approximately 86.6%. The consumed current, which is substantially in proportion to the bias current, can be reduced by 25%.

After the adjustment, the targeted drive voltage VH on the high-level side and the targeted drive voltage VL on the low-level side are alternately applied again in the Step S2 again so that the waveform is confirmed. Every time when the margin of the convergence time τs is excessive, the bias current is reduced to ¾, and the processing returns to the Step S2. The process of the adjustment is shown in the waveform of FIG. 10B.

By adjusting the performance necessary for the drive of the panel load as described above, it becomes possible to reduce power and drive the counter electrodes in such a manner that the convergence time τs is satisfied. The information of the control of the bias current thus obtained through the automatic adjustment may be memorized in a memory. The information of the control of the bias current thus obtained may be memorized in a register as an initial value, wherein the initial value of the control information of the bias current (automatic adjustment value) memorized in the register is supplied to the drive voltage control device from the start in the control of the bias current when the relevant panel is turned on and actually operated. As a result, the drive voltage control device can be suitably driven.

In the case where the load capacitance and the load resistance of the liquid crystal panel which are previously estimated are large and the voltage convergence is not possible at a speed equal to or higher than the assumption, or the voltage fails to reach the targeted drive voltage VH on the high-level side and the targeted drive voltage VL on the low-level side, the boost voltage VHH (=VH+ΔV) is caused to be generated so as to realize such an automatic adjustment that the convergence time τs is observed. In this case, the judgment in the Step S3 shows NO. In order to improve drive performance, the processing advances to Step S6, so that the increase amount of the boost voltage ΔV is set at 50 mV. When the rise of the voltage is not possible within the convergence time τs,

VH=VH+ΔV (16)

When the fall of the voltage is not possible within the convergence time τs,

VL=VL−ΔV (17)

When neither of the rise nor the fall of the voltage is possible within the convergence time τs,

VH=VH+ΔV, VL=VL−ΔV (18)

Then, the processing returns to the Step S2, and the Step S6 is repeated until the convergence time τs is satisfied, which is shown in FIG. 10C.

As a result of the automatic adjustment thus described, it is only necessary to control the drive voltage control device, while it is unnecessary to readjust or remanufacture the semiconductor device, in order to provide the drive voltage control device in which the convergence timers can be satisfied and the consumed current is appropriate, even when dealing with a panel whose load is different to the load previously grasped.

The description given so far is based on the condition that the internal through rate of the operation amplifier A1 is sufficiently larger than the external through rate thereof. In the case where the bias current of the operation amplifier A1 is increased to 1.5 times, or any other similar a processes are carried out, in addition to the adjustment of the increase amount ΔV of the boost voltage in the Step S6, the automatic adjustment can include the adjustment of the internal through rate.

Below is described, referring to FIG. 11, the modified embodiment of the preferred embodiment 3 wherein the load drive voltage can be converged to the targeted drive voltage within the requested convergence time τs irrespective of the load circuit. FIG. 11 is a circuit diagram according to the modified embodiment of the preferred embodiment 3, which shows a constitution of the drive voltage control device for the liquid crystal panel wherein the load drive voltage can be converged to the targeted drive voltage within the convergence time τ irrespective of the load circuit. The same components as those described earlier are provided with the same reference symbols. In FIG. 11, 5 denotes a comparator for comparing the load drive voltage and the targeted drive voltage, 6 denotes a boost voltage controller operated in accordance with a result of the comparison by the comparator 5, wherein the boost voltage VHH is dropped when the load drive voltage is higher than the targeted drive voltage, the boost voltage VHH is retained when the load drive voltage is equal to the targeted drive voltage, and the boost voltage VHH is increased when the load drive voltage is lower than the targeted drive voltage. In the example shown in the drawing, the boost voltage controller 6 comprises an operation circuit 7 and a DA converter 8. The boost voltage controller 6 is controlled by a predetermined timing by the timing controller 3, in other words, the operation circuit 7 and the DA converter 8 are timing-controlled. The operation circuit 7 actually calculates the increase amount ΔV of the boost voltage, and the DA converter 8 converts the calculated amount into an analog control signal, so that the boost voltage increase amount ΔV in the boost voltage VHH is adjusted.

In the modified embodiment, the convergence of the load drive voltage to the targeted drive voltage within the requested convergence time τs is described. In the case where the drive depends on only the operation amplifier A1, the load drive voltage is determined by the through rate of the operation amplifier A1 and the requested convergence time τs. At the time, in the case where the capacitance and the load of the load circuit 2 are sufficiently smaller than the internal through rate of the operation amplifier A1, and the through rate of the operation amplifier A1 is sufficiently high, the load drive voltage can be outputted within the requested convergence time τs. However, when the capacitance and the resistance of the load circuit 2 are large and the load is heavy, the load drive voltage is restricted by the time constant, which does not allow the convergence to the targeted drive voltage within the convergence time τs. On the other hand, in the case where the boost voltage VHH is selected as the input voltage, the load drive voltage overshoots when the boost voltage VHH is too high, which also results in the failure of voltage convergence. Further, the load of the load circuit 2 is not always constant due to the replacement of the liquid crystal panel and the variability in the manufacturing process.

Therefore, in the present modified embodiment, the comparator 5 and the boost voltage controller 6 are provided so that a change amount of the load circuit 2 or the time constant thereof is detected when there are any such changes and the boost voltage VHH optimum for the change amount is further supplied to the load drive voltage in order to realize the convergence toward the targeted drive voltage within the demanded convergence time τs.

When the load drive voltage is 0V, and the requested convergence time τs has passed, the comparator 5 compares the load drive voltage to the targeted drive voltage, and the operation circuit 7 executes the following computations based on a result of the comparison.

a) When the load drive voltage is equal to the targeted drive voltage, the boost voltage VHH is not changed.

b) When the load drive voltage is higher than the targeted drive voltage, the boost voltage VHH is changed to a voltage having an absolute value lower than that of the original boost voltage.

c) When the load drive voltage is lower than the targeted drive voltage, the boost voltage VHH is changed to a voltage having an absolute value higher than that of the original boost voltage.

When the foregoing control operation is repeatedly executed, the targeted drive voltage can be outputted within the requested convergence time τs despite the replacement of the liquid crystal panel or the variability of the liquid crystal panel. A case when the load drive voltage is equal to the targeted drive voltage, as described above, includes a case when the load drive voltage is within a range of error (for example, a range of the targeted drive voltage ±10 mV).

As described, the convergence of the load drive voltage to the targeted drive voltage within the requested convergence time τs can be surely realized despite the replacement of the liquid crystal panel or the variability of the load thereof.

Further, in the case of the same panel load and convergence time τs, the boost voltage VHH and the bias current may be the same. Therefore, it is unnecessary to change the processing by the comparator 5 unless the panel load or the convergence time τs is changed. After the panel load and the convergence time τs are set, and the convergence of the voltage to the optimum boost voltage is completed in a certain period of time, the value of the optimum boost voltage VHH can be memorized in the control register, which makes it unnecessary to operate the comparator 5. When the boost voltage VHH is set in a test conducted before the image is actually transferred to and displayed in the liquid crystal panel, the convergence time TS can be arbitrarily set while the following conditions are satisfied.

There is not power increase during the display.

The power consumption can be reduced irrespective of the panel load.

### Preferred Embodiment 4

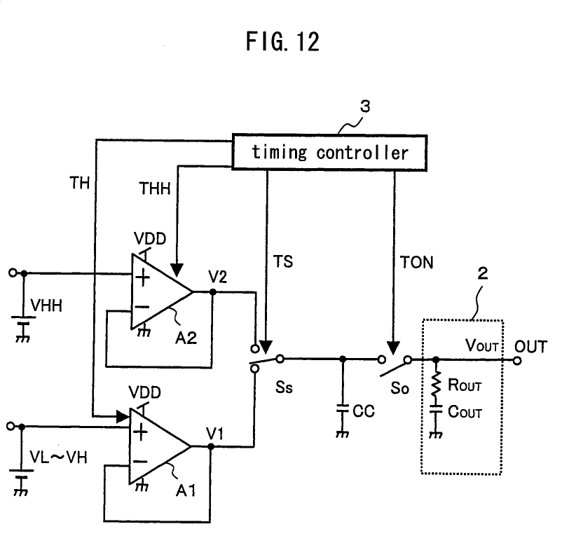

FIG. 12 is a circuit diagram illustrating a constitution of a drive voltage control device for a liquid crystal panel according to a preferred embodiment 4 of the present invention. The same components as those described earlier are provided with the same reference symbols. In FIG. 12, A1 denotes a first operation amplifier for inputting and impedance-converting the targeted drive voltage VH on the high-level side and then outputting a load drive voltage V1. A 2 denotes a second operation amplifier for inputting and impedance-converting the boost voltage VHH whose potential is higher than that of the targeted drive voltage VH on the high-level side and then outputting a boost voltage V2 higher than the load drive voltage V1. Ss denotes an output selection switch for selecting one of the load drive voltage V1 of the first operation amplifier A1 and the boost drive voltage V2 of the second operation amplifier A2. CC denotes a smoothing capacitor inserted between the output selection switch Ss and the ground. So denotes an output control switch inserted between the smoothing capacitor CC and the load circuit 2 of the liquid crystal panel. 3 denotes a timing controller.

The timing controller 3 switches on and off the output selection switch So based on a control signal TS, and switches on and off the output control switch So based on a control signal TON. The timing controller 3 further starts and halts the operation of the first and second operation amplifiers A1 and A2 based on control signals TH and THH.

The timing controller 3 controls the output selection switch Ss based on the control signal TS when the output control switch So is in the OFF state, and selects the boost voltage VHH of the second operation amplifier A2. The timing controller 3 then charges the smoothing capacitor CC with the boost voltage VHH. At the time, the power is turned off by the control signal TH with respect to the first operation amplifier A1 which is not selected so that the power consumption is reduced.

Next, the timing controller 3 switches on the output control switch So based on the control signal TON in accordance with the display timing, and applies the boost voltage VHH of the smoothing capacitor CC to the load circuit 2 of the liquid crystal panel. Accordingly, the load drive voltage V_{OUT} is increased. The increase of the load drive voltage V_{OUT} leads to the convergence toward the targeted drive voltage VH on the high-level side at such a high speed that corresponds to the time period shorter than the time constant decided by the load resistance R_{OUT} and the load capacitance C_{OUT} of the load circuit 2 of the liquid crystal panel. When the load drive voltage V_{OUT} has reached the targeted drive voltage VH on the high-level side, the output selection switch Ss is switched so that the load drive voltage V1 of the first operation amplifier A1 is selected. At the time, the second operation amplifier A2 which is not selected is turned off by the control signal THH so that the power consumption is reduced. With the internal through rate of the first operation amplifier A1 being set to be sufficiently high, the convergence of the load drive voltage V_{OUT} depends on the time constant decided by the load resistance R_{OUT} and the load capacitance C_{OUT} of the load circuit 2 of the liquid crystal panel when the targeted drive voltage VH on the high-level side is changed in accordance with the pixel data.

According to the present preferred embodiment, the high-speed convergence can be realized without any dependence on the internal through rate of the operation amplifier A1. Further, either of the first and second operation amplifiers A1 and A2 which is not selected is turned off so that the power consumption can be reduced.

### Preferred Embodiment 5

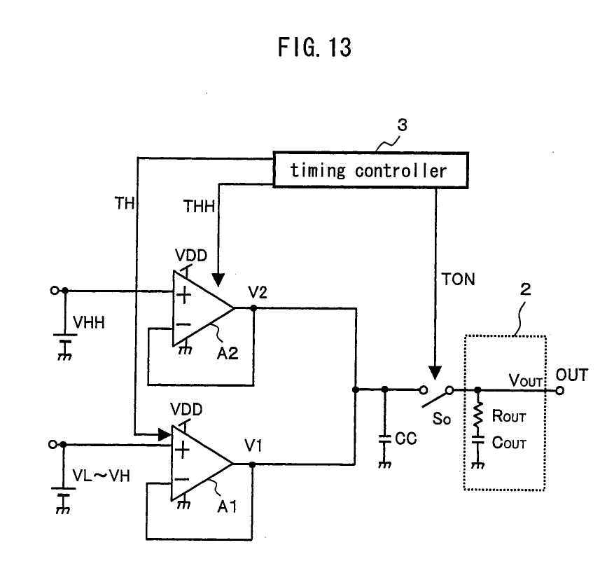

FIG. 13 is a circuit diagram illustrating a constitution of a drive voltage control device for a liquid crystal panel according to a preferred embodiment 5 of the present invention. The same components as those described earlier are provided with the same reference symbols. In the present preferred embodiment, the output selection switch Ss provided in FIG. 12 according to the preferred embodiment 4 is omitted. During the period when the boot drive voltage V2 of the second operation amplifier A2 is selected, the timing controller 3 puts the first operation amplifier A1 in a high-impedance state based on the control signal TH. During the period when the load drive voltage V1 of the first operation amplifier A1 is selected, the timing controller 3 puts the second operation amplifier A2 in the high-impedance state based on the control signal THH.

According to the present preferred embodiment, it is unnecessary to provide the output selection switch Ss between the first and second operation amplifiers A1 and A2 and the smoothing capacitor CC. Because the output impedance can be reduced, the operation can be further accelerated. Further, the voltage can be obtained in such a manner that any noise is not generated when the switch is changed.

### Preferred Embodiment 6

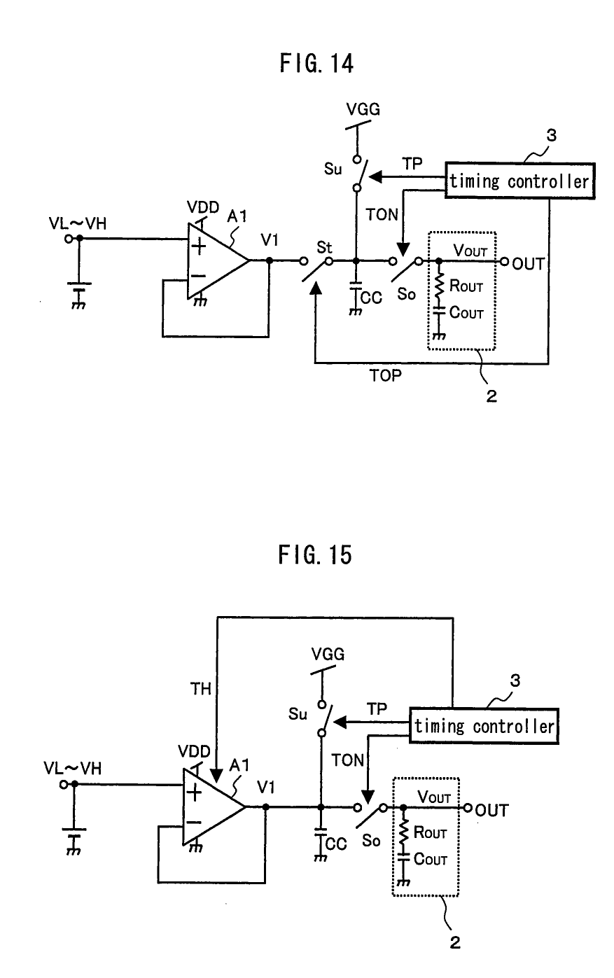

FIG. 14 is a circuit diagram illustrating a constitution of a drive voltage control device for a liquid crystal panel according to a preferred embodiment 6 of the present invention. The same components as those described earlier are provided with the same reference symbols. The load circuit 2 of the liquid crystal panel is connected to the output terminal of the operation amplifier A1 via a timing control switch St and the output control switch So. A connecting point between the timing control switch St and the output control switch So is connected to a power supply of the boost voltage VGG whose potential is higher than that of the targeted drive voltage VH on the high-level side via the voltage-increase control switch Su. Further, the smoothing capacitor CC is inserted between a connecting point between the timing control switch St and the output control switch So, and the ground. The timing controller 3 switches on and off the output control switch So based on the control signal TON, switches on and off the voltage-increase control switch Su based on the control signal TP, and switches on and off the timing control switch St based on the control signal TOP. The output control switch So is controlled based on the liquid crystal display timing.

The timing controller 3 switches on the voltage-increase control switch Su based on the control signal TP when the output control switch So is in the OFF state, and charges the smoothing capacitor CC with the boost voltage VGG. Then, the timing controller 3 switches off the voltage-increase control switch Su. The timing controller 3 further switches on the output control switch So in accordance with the display timing, and applies the boost voltage VGG of the smoothing capacitor CC to the load circuit 2 of the liquid crystal panel. Accordingly, the load drive voltage V_{OUT} is increased. The load drive voltage V_{OUT} at the time is increased and converged to the level of the targeted drive voltage VH on the high-level side at such a high speed that corresponds to the time period shorter than the time constant decided by the load resistance R_{OUT} and the load capacitance C_{OUT} of the load circuit 2 of the liquid crystal panel. When the load drive voltage V_{OUT} has reached the level of the targeted drive voltage VH on the high-level side, the timing control switch St is switched on by the control signal TOP, and the timing control switch St thereby selects the output V1 of the operation amplifier A1 by the targeted drive voltage VH on the high-level side.

According to the present preferred embodiment, the charges to be supplied to the load circuit 2 of the liquid crystal panel are stored in the smoothing capacitor CC in advance, which accelerates the operation. As a modified embodiment of the present preferred embodiment, as shown in FIG. 15, the timing control switch St may be omitted, and the output of the operation amplifier A1 may be put in the high-impedance state by the control signal TH from the timing controller 3. Further, the operation amplifier A1 may be turned off so that the power consumption can be reduced.

### Preferred Embodiment 7

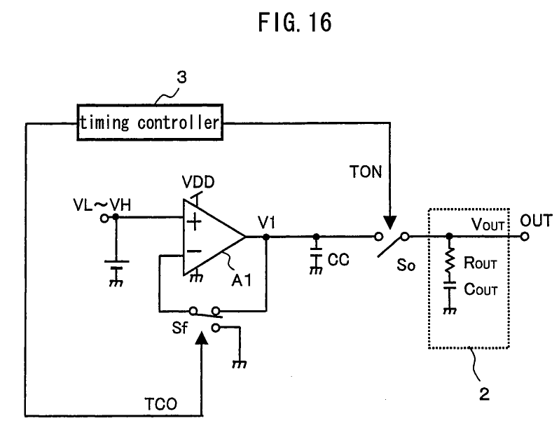

FIG. 16 is a circuit diagram illustrating a constitution of a drive voltage control device for a liquid crystal panel according to a preferred embodiment 7 of the present invention. The same components as those described earlier are provided with the same reference symbols. A feedback control switch Sf is inserted into a feedback line between the output terminal and the inversion input terminal (−) of the operation amplifier A1, and the feedback control switch Sf is switched on and off by a control signal TCO of the timing controller 3. The smoothing capacitor CC is inserted between the output terminal of the operation amplifier A1 and the ground. The output control switch So is inserted between the smoothing capacitor CC and the load circuit 2 of the liquid crystal panel. The output control switch SO is also switched on and off by the control signal TON of the timing controller 3.

The operation amplifier A1 switches on the feedback control switch Sf and short-circuits the inversion input terminal (−) with respect to the output terminal to thereby operate as a voltage follower, and switches off the feedback control switch Sf and short-circuits the inversion input terminal (−) with respect to the ground to thereby operate as a comparator. When operated as the comparator, the operation amplifier A1 outputs the “H” level (power supply voltage VDD).

The timing controller 3 puts the feedback control switch Sf in the OFF state during a certain period based on the control signal TCO when the output control switch So is in the OFF state. Accordingly, the inversion input terminal (−) of the operation amplifier A1 is short-circuited with respect to the ground, and the operation amplifier A1 functions as the comparator, thereby outputting the H level (power supply voltage VDD). As a result, the smoothing capacitor CC is charged by the power supply voltage VDD.

When the timing controller 3 switches on the output control switch So based on the control signal TON in accordance with the display timing, the smoothing capacitor CC speedily charges the load circuit 2 of the liquid crystal panel with the power supply voltage VDD. This charging is carried out at a high speed. When the load drive voltage V_{OUT} becomes substantially equal to the convergence targeted voltage in the load circuit 2 of the liquid crystal panel, the feedback control switch Sf is switched on, and the output terminal and the inversion input terminal (−) of the operation amplifier A1 are short-circuited with respect to each other, and the operation amplifier A1 accordingly functions as the voltage follower. As a result, the load drive voltage outputted from the operation amplifier A1 converges to the targeted drive voltage VH on the high-level side decided by the pixel data.

At the time, the smoothing capacitor CC is previously charged with the power supply voltage whose potential is higher than that of the convergence targeted voltage, and the load circuit 2 of the liquid crystal panel is charged by the smoothing capacitor CC. Therefore, when the voltage of the load circuit 2 is increased to the convergence targeted voltage, the convergence can be realize that such a high speed that corresponds to the time period shorter than the time constant of the load circuit 2.

### Preferred Embodiment 8

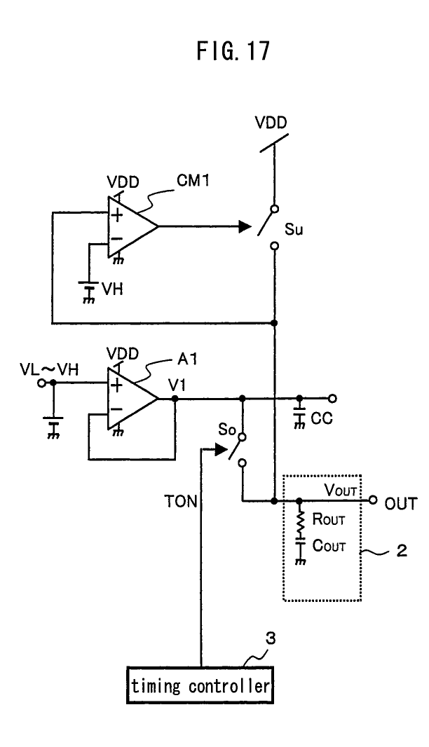

FIG. 17 is a circuit diagram illustrating a constitution of a drive voltage control device for a liquid crystal panel according to a preferred embodiment 8 of the present invention. The same components as those described earlier are provided with the same reference symbols. A comparator CM1 is provided apart from the operation amplifier A1. The smoothing capacitor CC is connected to the output terminal of the operation amplifier A1, and the load circuit 2 of the liquid crystal panel is also connected thereto via the output control switch So. A connecting point between the output control switch So and the load circuit 2 is connected to the power supply voltage VDD via the voltage-increase control switch Su. The voltage-increase control switch Su is controlled to be ON and OFF by an output of the comparator CM1. A non-inversion input terminal (+) of the comparator CM1 is connected to the connecting point between the output control switch So and the load circuit 2, and a predetermined reference voltage (VH−ΔV) is applied to an inversion input terminal (−) thereof.

The smoothing capacitor CC is charged with the load drive voltage outputted from the operation amplifier A1. The charged voltage at the time is a voltage corresponding to the targeted drive voltage VH on the high-level side in accordance with the pixel data inputted to the operation amplifier A1. The timing controller 3 switches on the output control switch So based on the control signal TON. At the time, the voltage to be applied to the non-inversion input terminal (+) of the comparator CM1 is relatively low, and the comparator CM1 thereby outputs the “L” level. Accordingly, the voltage-increase control switch Su is in the ON state. Therefore, the power supply voltage VDD on the high-level side is applied to the load circuit 2 via the voltage-increase control switch Su, and the power supply voltage VDD on the high-level side is further applied to the smoothing capacitor CC via the output control switch So. As a result, the smoothing capacitor CC is charged with the power supply voltage VDD. The comparator CM1 compares the voltage applied to the load circuit 2 to the reference voltage. When the applied voltage with respect to the load circuit 2 has reached the reference voltage as the charging operation for the smoothing capacitor CC advances, the “H” level is outputted from the comparator CM1, and the voltage-increase control switch Su is turned off. The output control switch So remains ON, and the targeted drive voltage VH on the high-level side in accordance with the pixel data inputted to the operation amplifier A1 is reflected on the load circuit 2.

According to the present preferred embodiment, because the power supply voltage VDD on the high-level side is applied to the smoothing capacitor CC, the effective operation of the load circuit 2 of the liquid crystal panel can be performed at a high speed.

As a possible constitution, the operation of the operation amplifier A1 may be halted during the period when the comparator CM1 is operated, and the operation of the comparator CM1 may be halted during the period when the operation amplifier A1 is operated, which results in the reduction of the power consumption.

### Preferred Embodiment 9

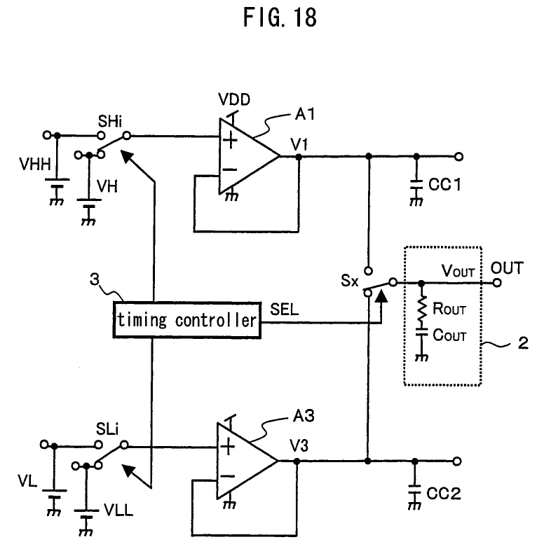

FIG. 18 is a circuit diagram illustrating a constitution of a drive voltage control device for a liquid crystal panel according to a preferred embodiment 9 of the present invention. The same components as those described earlier are provided with the same reference symbols. The present preferred embodiment is characterized in that the load drive voltage for AC-driving the load circuit 2 of the liquid crystal panel is generated. The load drive voltage is a power supply voltage for driving the counter electrodes necessary for the line inversion in the liquid crystal panel, and for alternately outputting a positive-electrode-side potential (for example, +3V) and a negative-electrode-side potential (for example, −3V) suitable for driving the liquid crystal panel.

A targeted drive voltage VH on a positive-electrode-side high-level side and a positive-electrode-side boost voltage VHH higher than the targeted drive voltage VH on the high-level side are selectively inputted to a non-inversion input terminal (+) of a positive-electrode-side operation amplifier A1 via an input selection switch SHi. A difference between the targeted drive voltage VH on the high-level side and the positive-electrode-side boost voltage VHH is calculated based on the formula 1). An inversion input terminal (−) of the positive-electrode-side operation amplifier A1 is connected to an output terminal thereof. A smoothing capacitor CC1 is connected to the output terminal of the positive-electrode-side operation amplifier A1.

A targeted drive voltage VL on a negative-electrode-side low-level side and a negative-electrode-side boost voltage VLL lower than the targeted drive voltage VL on the low-level side are selectively inputted to a non-inversion input terminal (+) of a negative-electrode-side operation amplifier A3 via an input selection switch SLi. A difference between the targeted drive voltage VL on the low-level side and the negative-electrode-side boost voltage VLL is calculated based on the formula 1). An inversion input terminal (−) of the negative-electrode-side operation amplifier A3 is connected to an output terminal thereof. A smoothing capacitor CC2 is connected to the output terminal of the negative-electrode-side operation amplifier A3.

The output terminal of the positive-electrode-side operation amplifier A1 and the output terminal of the negative-electrode-side operation amplifier A3 are selectively connected to the load circuit 2 of the liquid crystal panel via an output switch Sx. The timing controller 3 switches the output switch Sx on and off based on a control signal SEL in accordance with the display timing. The timing controller 3 further timing-controls the input selection switch Shi and the input selection switch SLi.

The operation of the drive voltage control device according to the present preferred embodiment thus constituted is described below.

i) During the period over which the output switch Sx selects the output of the negative-electrode-side operation amplifier A3, the positive-electrode-side input selection switch SHi selects the positive-electrode-side boost voltage VHH on the high-level side, which is supplied to the positive-electrode-side operation amplifier A1. Accordingly, the positive-electrode-side smoothing capacitor CC1 is charged with the positive-electrode-side boost voltage VHH on the high-level side. At the time, the negative-electrode-side input selection switch SLi selects the targeted drive voltage VL on the low-level side, which is supplied to the negative-electrode-side operation amplifier A3. Because the output terminal of the negative-electrode-side operation amplifier A3 is connected to the load circuit 2 of the liquid crystal panel via the output switch Sx, the load circuit 2 is driven by the low-potential-side targeted drive voltage VL on the minus side.

ii) During the period over which the output switch Sx selects the output of the positive-electrode-side operation amplifier A1, the negative-electrode-side input selection switch SLi selects the negative-electrode-side boost voltage VLL on the low-level side, which is supplied to the negative-electrode-side operation amplifier A3. Accordingly, the negative-electrode-side smoothing capacitor CC2 is charged with the negative-electrode-side boost voltage VLL on the low-level side. At the time, the positive-electrode-side input selection switch SHi selects the targeted drive voltage VH on the high-level side, which is supplied to the positive-electrode-side operation amplifier A1. Because the output terminal of the positive-electrode-side operation amplifier A1 is connected to the load circuit 2 of the liquid crystal panel via the output switch Sx, the load circuit 2 is driven by the high-potential-side targeted drive voltage VH on the plus side.

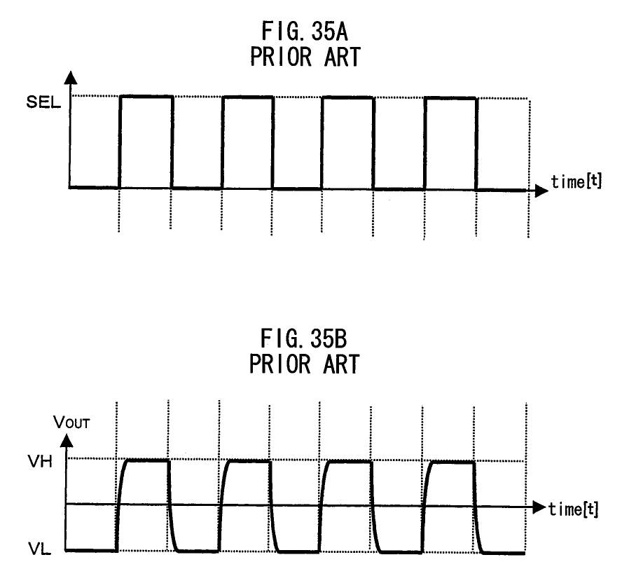

The timing controller 3 switches between the state in i) and the state in ii) in an alternative manner by the output switch Sx. When i) shifts to ii), the smoothing capacitor CC1 is already fully charged with the positive-electrode-side boost voltage VHH on the high-level side. Therefore, the load drive voltage V_{OUT} to be supplied to the load circuit 2 is speedily converged to the convergence targeted voltage. In a similar manner, when ii) shifts to i), the smoothing capacitor CC2 is already fully charged with the negative-electrode-side boost voltage VLL on the low-level side. Therefore, the load drive voltage V_{OUT} to be supplied to the load circuit 2 is speedily converged to the convergence targeted voltage. When the foregoing operation is cyclically repeated, an output waveform shown in FIG. 35A can be obtained.

According to the present preferred embodiment, in the drive voltage control device for driving the liquid crystal panel, the load can be driven at such a high speed that corresponds to the time period shorter than the time constant decided by the load (C_{OUT}×R_{OUT}) of the liquid crystal panel.

### Preferred Embodiment 10

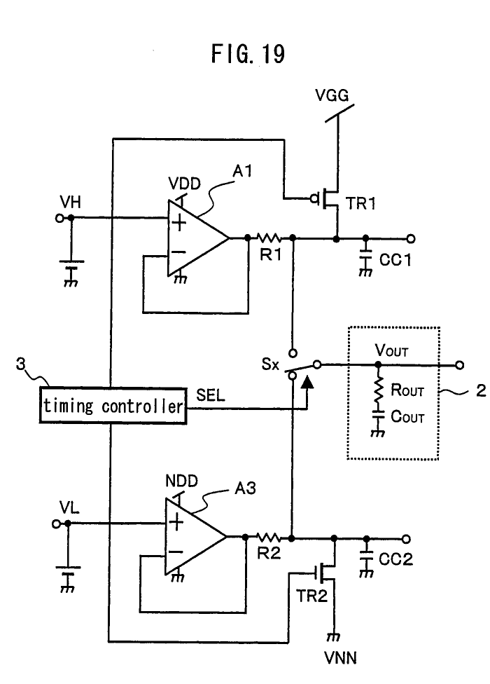

FIG. 19 is a circuit diagram illustrating a constitution of a drive voltage control device for a liquid crystal panel according to a preferred embodiment 10 of the present invention. The same components as those described earlier are provided with the same reference symbols.

The positive-electrode-side smoothing capacitor CC1 is inserted between the output terminal of the positive-electrode-side operation amplifier A1 and the ground. The power supply of the positive-electrode-side boost voltage VGG higher than the positive-electrode-side targeted drive voltage VH on the high-level side is connected to the output terminal of the positive-electrode-side operation amplifier A1 via a positive-electrode-side voltage-increase control switch TR1. The negative-electrode-side smoothing capacitor CC2 is inserted between the output of the negative-electrode-side operation amplifier A3 and the ground. The power supply of the negative-electrode-side boost voltage VNN lower than the negative-electrode-side targeted drive voltage VL on the low-level side is connected to the output terminal of the negative-electrode-side operation amplifier A3 via a negative-electrode-side voltage-increase control switch TR2. The output terminal of the positive-electrode-side operation amplifier A1 and the output terminal of the negative-electrode-side operation amplifier A3 are connected to the load circuit via the output switch Sx. The timing controller 3 alternately switches on and off the output switch Sx by a predetermined timing. The timing controller 3 further timing-controls the positive-electrode-side voltage-increase control switch TR1 and the negative-electrode-side voltage-increase control switch TR2. When the output switch Sx selects the output of the positive-electrode-side operation amplifier A1, the negative-electrode-side voltage-increase control switch TR2 is switched on. When the output switch Sx selects the output of the negative-electrode-side operation amplifier A3, the positive-electrode-side voltage-increase control switch TR1 is switched on.

i) During the period over which the output switch Sx selects the output of the negative-electrode-side operation amplifier A3 by the control of the timing controller 3, the negative-electrode-side smoothing capacitor CC2 is already fully charged with the negative-electrode-side boost voltage VNN on the negative side, and the negative-electrode-side operation amplifier A3 inputs a negative-electrode-side input signal to the load circuit 2 in the state where the voltage is stable. Then, the positive-electrode-side voltage-increase control switch TR1 is switched on, which starts the charging operation for the positive-electrode-side smoothing capacitor CC1 with the positive-electrode-side boost voltage VGG on the high-level side.

ii) During the period over which the output switch Sx selects the output of the positive-electrode-side operation amplifier A1 by the control of the timing controller 3, the positive-electrode-side smoothing capacitor CC1 is already fully charged with the positive-electrode-side boost voltage VGG on the positive side, and the positive-electrode-side operation amplifier A1 supplies a positive-electrode-side input signal to the load circuit 2 in the state where the voltage is stable. Then, the negative-electrode-side voltage-increase control switch TR2 is switched on, which starts the charging operation for the negative-electrode-side smoothing capacitor CC2 with the negative-electrode-side boost voltage VNN on the low-level side. The timing controller 3 alternately switches between the state in i) and the state in ii) by the output switch Sx.

When i) shifts to ii), the positive-electrode-side smoothing capacitor CC1 is already fully charged with the positive-electrode-side boost voltage VGG. Therefore, the load drive voltage to be supplied to the load circuit 2 is speedily converged to the convergence targeted voltage. In a similar manner, when ii) shifts to i), the negative-electrode-side smoothing capacitor CC2 is already fully charged with the negative-electrode-side boost voltage VNN. Therefore, the load drive voltage to be supplied to the load circuit 2 is speedily converged to the convergence targeted voltage. When the foregoing operation is cyclically repeated, the voltage waveform for AC-driving the load can be obtained. As result, the load can be driven at such a high speed that corresponds to the time period shorter than the time constant decided by the load of the liquid crystal panel.

### Preferred Embodiment 11

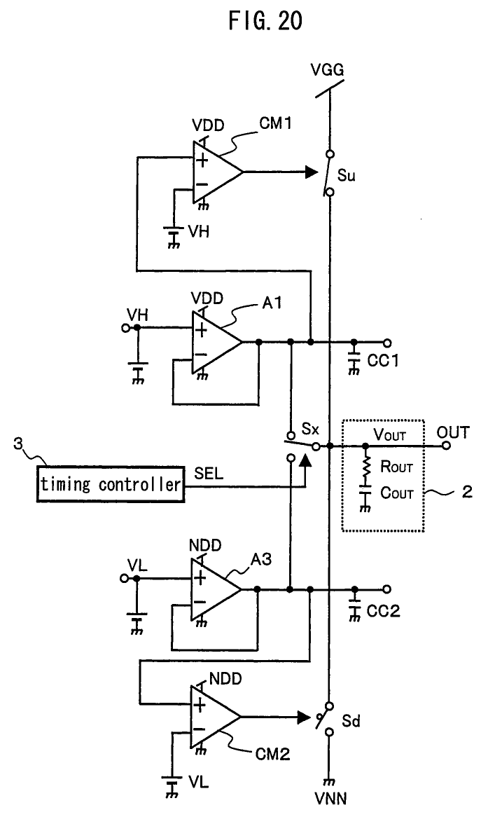

FIG. 20 is a circuit diagram illustrating a constitution of a drive voltage control device for a liquid crystal panel according to a preferred embodiment 11 of the present invention. The same components as those described earlier are provided with the same reference symbols.

The positive-electrode-side smoothing capacitor CC1 is inserted between the output terminal of the positive-electrode-side operation amplifier A1 and the ground. The negative-electrode-side smoothing capacitor CC2 is inserted between the output terminal of the negative-electrode-side operation amplifier A3 and the ground. The output of the positive-electrode-side operation amplifier A1 and the output of the negative-electrode-side operation amplifier A3 are connected to the load circuit 2 via the output switch Sx. The timing controller 3 timing-controls the output switch Sx.

A connecting point between the output switch Sx and the load circuit 2 is connected to the power supply of the positive-electrode-side boost voltage VGG higher than the positive-electrode-side targeted drive voltage VH on the high-level side via the positive-electrode-side voltage-increase control switch Su. The connecting point between the output switch Sx and the load circuit 2 is connected to the power supply of the negative-electrode-side boost voltage VNN lower than the negative-electrode-side targeted drive voltage VL on the low-level side via the negative-electrode-side voltage-increase control switch Sd.

The components further provided are: a positive-electrode-side comparator CM1 for monitoring the potential of the positive-electrode-side smoothing capacitor CC1, the positive-electrode-side comparator CM1 further controlling the positive-electrode-side voltage-increase control switch Su so that it is in the ON state when the monitored potential is below a predetermined reference voltage and controlling the positive-electrode-side voltage-increase control switch Su so that it is in the OFF state when the monitored potential is at least the predetermined reference voltage; and a negative-electrode-side comparator CM2 for monitoring the potential of the negative-electrode-side smoothing capacitor CC2, the negative-electrode-side comparator CM2 further controlling the negative-electrode-side voltage-increase control switch Sd so that it is in the ON state when the monitored potential is over a predetermined reference voltage and controlling the negative-electrode-side voltage-increase control switch Sd so that it is in the OFF state when the monitored potential is at most the predetermined reference voltage.

Below is described the operation of the drive voltage control device according to the present preferred embodiment thus constituted.

i) During the period over which the timing controller 3 controls the output switch Sx to select the output of the positive-electrode-side operation amplifier A1, the positive-electrode-side voltage-increase control switch Su is in the ON state, and the positive-electrode-side boost voltage VGG is applied to the positive-electrode-side smoothing capacitor CC1 via the output switch Sx, which starts the charging operation with respect to the positive-electrode-side smoothing capacitor CC1 with the positive-electrode-side boost voltage VGG. The charged voltage of the positive-electrode-side smoothing capacitor CC1 is applied to the load circuit 2. The applied voltage with respect to the load circuit 2 is monitored by the positive-electrode-side comparator CM1. The positive-electrode-side voltage-increase control switch Su is controlled to be in the ON state when the monitored voltage is below the predetermined reference voltage, while the positive-electrode-side voltage-increase control switch Su is controlled to be in the OFF state when the monitored voltage is at least the predetermined reference voltage. After that, the smoothing capacitor CC1 is charged with only the targeted drive voltage VH on the high-level side from the positive-electrode-side operation amplifier A1. The applied voltage with respect to the load circuit 2 is also applied to the non-inversion input terminal (+) of the negative-electrode-side comparator CM2. From the comparator CM2 is outputted the “H” level, and the negative-electrode-side voltage-increase control switch Sd is retained in the OFF state. Therefore, the output voltage OUT is not affected at all by the negative-electrode-side boost voltage VNN.

In the foregoing case, the positive-electrode-side boost voltage VGG is applied to the load circuit 2 in an initial stage after the power supply is turned on and in an initial stage after the output switch Sx is switched from the negative side to the positive side. Therefore, the load drive voltage V_{OUT} with respect to the load circuit 2 is converged to the convergence targeted voltage at a high speed.

ii) During a period over which the timing controller 3 controls the output switch Sx to select the output of the negative-electrode-side operation amplifier A3, the negative-electrode-side voltage-increase control switch Sd is in the ON state, and the negative-electrode-side boost voltage VNN is applied to the negative-electrode-side smoothing capacitor CC2 via the output switch Sx, which starts the charging operation with respect to the negative-electrode-side smoothing capacitor CC2 with the negative-electrode-side boost voltage VNN. The charged voltage of the negative-electrode-side smoothing capacitor CC2 is applied to the load circuit 2. The applied voltage with respect to the load circuit 2 is monitored by the negative-electrode-side comparator CM2. The negative-electrode-side voltage-increase control switch Sd is controlled to be in the ON state when the monitored voltage is over the predetermined reference voltage, while the negative-electrode-side voltage-increase control switch Sd is controlled to be in the OFF state when the monitored voltage is at most the predetermined reference voltage. After that, the smoothing capacitor CC2 is charged with only the targeted drive voltage VL on the low-level side from the negative-electrode-side operation amplifier A3. The applied voltage with respect to the load circuit 2 is also applied to the non-inversion input terminal (+) of the positive-electrode-side comparator CM1. From the comparator CM1 is outputted “L” level, and the positive-electrode-side voltage-increase control switch Su is retained in the OFF state. Therefore, the output voltage OUT is not affected at all by the positive-electrode-side boost voltage VGG.

In the foregoing case, the negative-electrode-side boost voltage VNN is applied to the load circuit 2 in an initial stage after the power supply is turned on and in an initial stage after the output switch Sx is switched from the positive side to the negative side. Therefore, the load drive voltage V_{OUT} with respect to the load circuit 2 is converged to the convergence targeted voltage at a high speed.

The timing controller 3 alternately switches between the state in i) and the state in ii) by the output switch Sx.

According to the present preferred embodiment, the load can be driven at such a high speed that corresponds to the time period shorter than the time constant decided by the load of the liquid crystal panel on both of the positive and negative sides in order to obtain the voltage waveform for AC-driving the load. Further, the applied voltage with respect to the load circuit 2 is monitored by the positive-electrode-side comparator CM1 and the negative-electrode-side comparator CM2 so that the voltage-increase control switches Su and Sd are controlled. As a result, a high precision can be attained in the timing control.

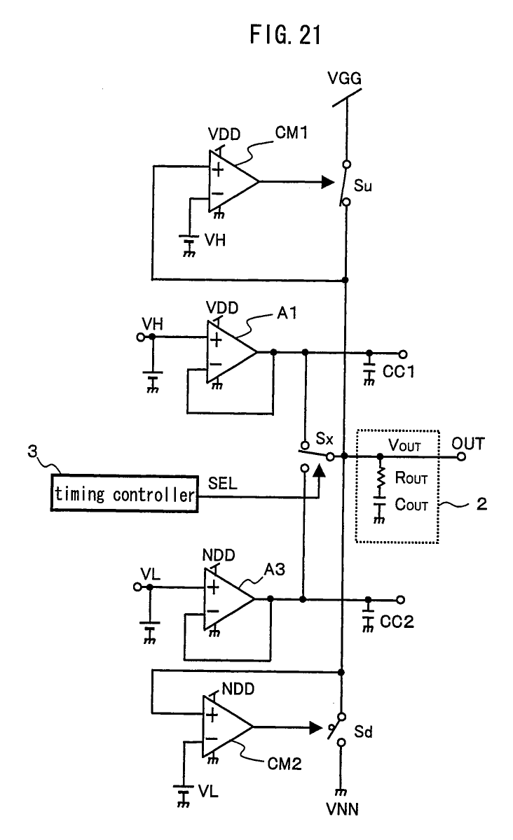

The present preferred embodiment includes a modified embodiment shown in FIG. 21. In the modified embodiment, the boost function is exerted irrespective of the voltage of the smoothing capacitor CC1. According to the constitution, the drive by the operation amplifiers A1 and A3 is limited to the voltage level close to the convergence voltage, and the boost function covers the drive before the voltage is around the convergence voltage. Therefore, a higher speed can be achieved in the voltage convergence. Further, the constitution does not largely depend on the performance of the operation amplifiers A1 and A3, which makes it easy to design the operation amplifiers A1 and A3.

### Preferred Embodiment 12

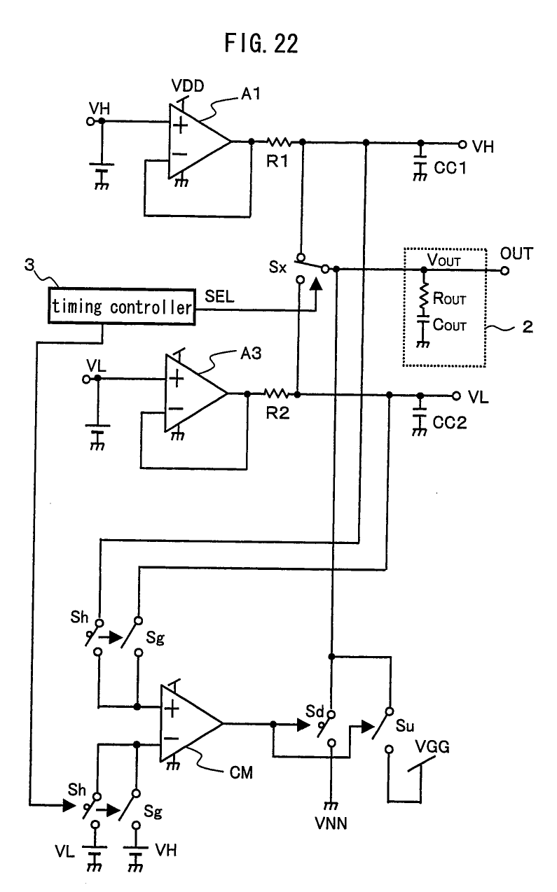

FIG. 22 is a circuit diagram illustrating a constitution of a drive voltage control device for a liquid crystal panel according to a preferred embodiment 12 of the present invention. The same components as those described earlier are provided with the same reference symbols. The present preferred embodiment is characterized in that a comparator is used in place of the positive-electrode-side comparator CM1 and the negative-electrode-side comparator CM2 provided in the preferred embodiment 11 shown in FIG. 20. The connecting point between the output switch Sx and the load circuit 2 is connected to the power supply of the positive-electrode-side boost voltage VGG higher than the positive-electrode-side targeted drive voltage VH on the high-level side via the positive-electrode-side voltage-increase control switch Su, and the connecting point of the output switch Sx and the load circuit 2 is connected to the power supply of the negative-electrode-side boost voltage VNN lower than the negative-electrode-side targeted drive voltage VL on the low-level side via the negative-electrode-side voltage-increase control switch Sd in a manner similar to FIG. 17. However, a comparator CM for controlling both of the positive-electrode-side voltage-increase control switch Su and the negative-electrode-side voltage-increase control switch Sd in a reverse manner relative to each other is provided. A non-inversion input terminal (+) of the comparator CM is connected to the output terminal of the output switch Sx. Further, a positive-electrode-side reference potential and a negative-electrode-side reference potential are connected to an inversion input terminal (−) of the comparator CM via reference potential switches Sh and Sg. The comparator CM compares the reference potential supplied from one of the reference potential switches Sh and Sg to the applied voltage of the load circuit 2, and switches on and off the positive-electrode-side voltage-increase control switch Su and the negative-electrode-side voltage-increase control switch Sd in the reverse manner relative to each other based on a result of the comparison. The timing controller 3 timing-controls the output switch Sx and the reference potential switches Sh and Sg.

The operation of the drive voltage control device according to the present preferred embodiment thus constituted is described below.

i) During the period over which the timing controller 3 controls the output switch Sx so that the output of the positive-electrode-side operation amplifier A1 is selected, the timing controller 3 switches on the reference potential switch Sh and switches off the reference potential switch Sg. The positive-electrode-side voltage-increase control switch Su is in the ON state, while the negative-electrode-side voltage-increase control switch Sd is in the OFF state. The positive-electrode-side boost voltage VGG is applied to the positive-electrode-side smoothing capacitor CC1 via the positive-electrode-side voltage-increase control switch Su and the output switch Sx, as a result of which the smoothing capacitor CC1 starts being charged with the positive-electrode-side boost voltage VGG. The charged voltage thus supplied to the smoothing capacitor CC1 is applied to the load circuit 2. The applied voltage of the load circuit 2 is monitored by the comparator CM. As a result of the comparison, the positive-electrode-side voltage-increase control switch Su is retained in the ON state when the voltage is below the predetermined reference voltage, while the positive-electrode-side voltage-increase control switch Su is retained in the OFF state when the voltage is at least the predetermined reference voltage. After that, the smoothing capacitor CC1 is charged with only the targeted drive voltage VH on the high-level side from the positive-electrode-side operation amplifier A1. The negative-electrode-side voltage-increase control switch Sd is retained in the OFF state.

In the foregoing case, the positive-electrode-side boost voltage VGG is applied to the load circuit 2 in the initial stage after the power supply is turned on and in the initial stage after the output switch Sx is switched from the negative side to the positive side. Therefore, the load drive voltage V_{OUT} supplied to the load circuit 2 is converged to the convergence targeted voltage at a high speed.

ii) During the period over which the timing controller 3 controls the output switch Sx so that the output of the negative-electrode-side operation amplifier A3 is selected, the timing controller 3 switches on the reference potential switch Sg and switches off the reference potential switch Sh. The negative-electrode-side voltage-increase control switch Sd is in the ON state, while the positive-electrode-side voltage-increase control switch Su is in the OFF state. The negative-electrode-side boost voltage VNN is applied to the negative-electrode-side smoothing capacitor CC2 via the negative-electrode-side voltage-increase control switch Sd and the output switch Sx, as a result of which the smoothing capacitor CC2 starts being charged with the negative-electrode-side boost voltage VNN. The charged voltage thus supplied to the smoothing capacitor CC2 is applied to the load circuit 2. The applied voltage of the load circuit 2 is monitored by the comparator CM. As a result of the comparison by the comparator CM, the negative-electrode-side voltage-increase control switch Sd is retained in the ON state when the relevant voltage is over the predetermined reference voltage, while the negative-electrode-side voltage-increase control switch Sd is retained in the OFF state when the relevant voltage is at most the predetermined reference voltage. After that, the smoothing capacitor CC2 is charged with only the targeted drive voltage VL on the low-level side outputted from the negative-electrode-side operation amplifier A3. The positive-electrode-side voltage-increase control switch Su is retained in the OFF state.

In the foregoing case, the negative-electrode-side boost voltage VNN is applied to the load circuit 2 in the initial stage after the power supply is turned on and in the initial stage after the output switch Ss is switched from the positive side to the negative side. Therefore, the load drive voltage V_{OUT} supplied to the load circuit 2 is converged to the convergence targeted voltage at a high speed.

The timing controller alternately switches between the state in i) and the state in ii) by the output switch Sx.

As described, according to the present preferred embodiment, the load can be driven at such a high speed that corresponds to the time period shorter than the time constant decided by the load of the liquid crystal panel on both of the positive and negative sides in order to obtain the voltage waveform for AC-driving the load in a manner similar to the preferred embodiments described so far. Further, the comparator which covers the positive and negative sides is used as the comparator for monitoring the applied voltage with respect to the load circuit 2 in order to control the ON and OFF of the voltage-increase control switches Su and Sd so that the timing control can be more precise. As a result, the circuit configuration can be simplified.

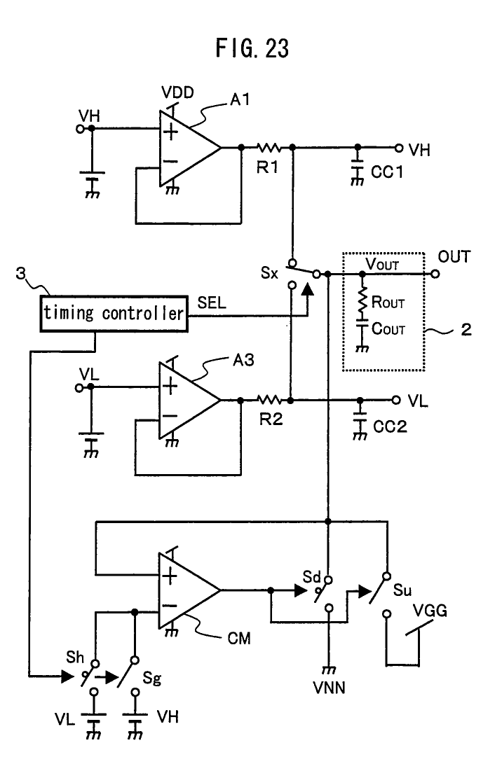

The present preferred embodiment includes a modified embodiment shown in FIG. 23. In the modified embodiment, the boost function is exerted irrespective of the voltage of the smoothing capacitor CC1. According to the constitution, the drive by the operation amplifiers A1 and A3 is limited to the voltage level close to the convergence voltage, and the boost function covers the drive before the voltage is around the convergence voltage. Therefore, a higher speed can be achieved in the voltage convergence. Further, the constitution does not largely depend on the performance of the operation amplifiers A1 and A3, which makes it easy to design the operation amplifiers A1 and A3.

### Preferred Embodiment 13

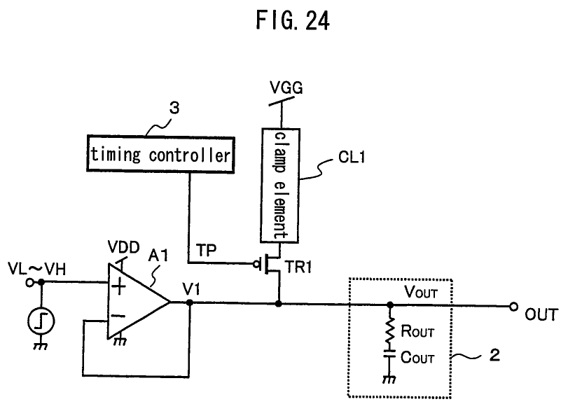

FIG. 24 is a circuit diagram illustrating a constitution of a drive voltage control device for a liquid crystal panel according to a preferred embodiment 13 of the present invention. In FIG. 24, the same components shown as those described earlier are provided with the same reference symbols. The present preferred embodiment is characterized in that a low-breakdown-voltage transistor TR1 and a clamp element CL1 are provided in place of the voltage-increase control switch Su shown in FIG. 4 according to the present preferred embodiment 2. A serial circuit comprising the low-breakdown-voltage transistor TR1 and the clamp element CL1 is inserted between the boost voltage VGG and the output terminal of the operation amplifier A1. The ON and OFF of the low-breakdown-voltage transistor TR1 is controlled by the timing controller 3.

It is assumed that VH of the input signal=3.0 V, and VGG of the boost voltage=10 V, and the clamp element CL1 is not provided. 7 V, which is a difference there between (=VGG−VH), is applied to the low-breakdown-voltage transistor, and the breakdown voltage of at least 7V is necessary for the drive voltage control device. In general, when the breakdown voltage of a transistor is increased, the thickness of a gate oxide film is increased, and a threshold voltage VT is also increased. As a result, the ON resistance of the transistor is increased in comparison to any transistor having a low breakdown voltage. When the ON resistance of the low-breakdown-voltage transistor is increased, the IR drop is generated when a high voltage is applied, which makes it not possible to output the set level. Further, the increased thickness of the gate oxide film consequently generates a delay in the signal from the timing controller 3 due to a capacitance thereby generated, which makes it difficult to realize the high-speed control. Therefore, the clamp element CL1 is inserted between the low-breakdown-voltage transistor TR1 and the boost voltage VGG, and then, the low-breakdown-voltage transistor TR1 is provided. As a result, the boost voltage VGG can be set to be high, and even a higher speed can be achieved.

The rest of the constitution and the operation, which are similar to those of the preferred embodiment 2, are not described again. The constitution according to the present preferred embodiment is applicable to the constitutions shown in FIGS. 7, 14, 15, 17, 19, 20, 21, 22, and 23.

### Preferred Embodiment 14

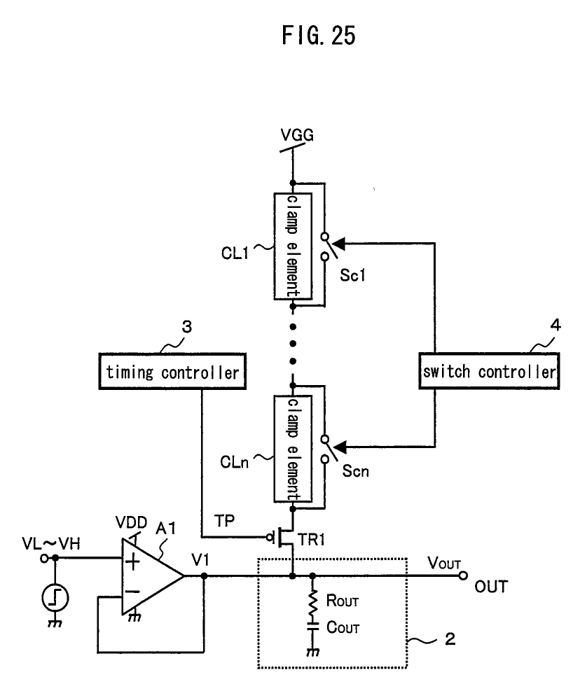

FIG. 25 is a circuit diagram illustrating a constitution of a drive voltage control device for a liquid crystal panel according to a preferred embodiment 14 of the present invention. In FIG. 25, the same components shown as those described earlier are provided with the same reference symbols. The present preferred embodiment is characterized in that a plurality of clamp elements are provided. More specifically, n number of clamp elements CL1, . . . , CLn are serially connected and inserted between the boost voltage VGG and the low-breakdown-voltage TR1. Further, clamp control switches Sc1, . . . , Scn for short circuit are connected in parallel to the clamp elements CL1, . . . , CLn, and the clamp control switches Sc1, . . . , Scn are switched on and off by a switch controller 4.

The load of the liquid crystal panel is variable in the range of, approximately, 1 nF-100 nF depending on the material of the liquid crystal panel. It is difficult to handle the different loads in the same circuit in terms of the speed, stability of the drive circuit and the like. In the present preferred embodiment, the switch controller 4 controls the ON and OFF of the clamp control switches Sc1, . . . , Scn so that the number of the effective clamp elements is adjusted. Thus, the variability described earlier can be appropriately handled in such a manner that the operation amplifier A1 is commonly used.

More specifically, in the case of the liquid crystal panel having a small load, the number of the switches to be ON is increased, and the number of the effective clamp elements is reduced. In addition to that, the boost voltage VGG may be set to be relatively low.

On the other hand, in the case of the liquid crystal panel having a large load, the number of the switches to be ON is reduced and the number of the effective clamp elements is increased. The clamp of each clamp element is approximately 0.7 V to 1.0 V. Therefore, the number of the clamp elements is calculated based on the difference between the load drive voltage V_{OUT} and the boost voltage VGG, and the switch controller 4 is controlled based on a result of the calculation so that the low-breakdown-voltage transistor TR1 can be adopted. In addition to that, the boost voltage VGG may be set to be relatively high.

According to the present preferred embodiment, the liquid crystal panels of a plurality of types respectively having different loads can be driven at such a high speed that corresponds to the time period shorter than the time constant decided by each of the loads.

The constitution according to the present preferred embodiment is applicable to the constitutions shown in FIGS. 7, 14, 15, 17, 19, 20, 21, 22, and 23.

### Preferred Embodiment 15

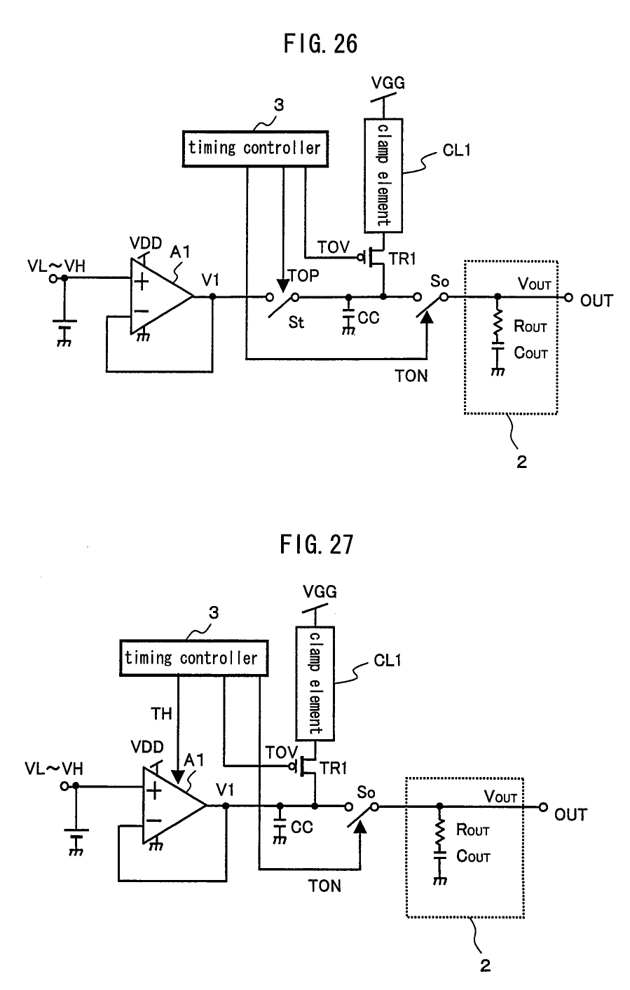

FIG. 26 is a circuit diagram illustrating a constitution of a drive voltage control device for a liquid crystal panel according to a preferred embodiment 15 of the present invention. The same components shown as those described earlier are provided with the same reference symbols. The present preferred embodiment is characterized in that the voltage-increase control switch Su is replaced with the low-breakdown-voltage transistor TR1 and the clamp element CL1 in the constitution according to the preferred embodiment 6 (see FIG. 14). In the present preferred embodiment, the IR drop at the time when a high voltage is applied can be controlled, and further, the operation in the high voltage application can be accelerated.

FIG. 27 is a circuit diagram illustrating a constitution of a drive voltage control device for a liquid crystal panel according to a modified embodiment 1 of the preferred embodiment 15. In the modified embodiment, the timing control switch St shown in FIG. 26 is omitted, and the operation amplifier A1 has a high-impedance function instead. Accordingly, the low-impedance drive can be realized.

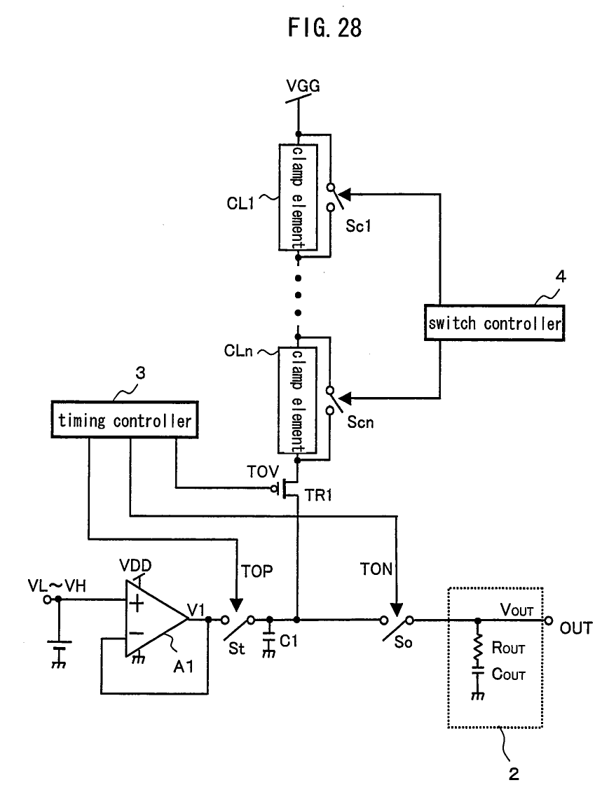

FIG. 28 is a circuit diagram illustrating a constitution of a drive voltage control device for a liquid crystal panel according to a modified embodiment 2 of the preferred embodiment 15. In the modified embodiment, the n number of clamp elements CL1, . . . , CLn which are serially connected in place of one clamp element CL1 shown in FIG. 26, clamp control switches Sc1, Scn for short circuit which are connected in parallel to the clamp elements CL1, . . . , CLn, and switch controller 4 for controlling on and off of clamp control switches Sc1, . . . , Scn are provided in a manner similar to FIG. 25. According to the present preferred embodiment, the liquid crystal panels of a plurality of types respectively having different loads can be driven at such a high speed that corresponds to a time period shorter than the time constant decided by each of the loads.

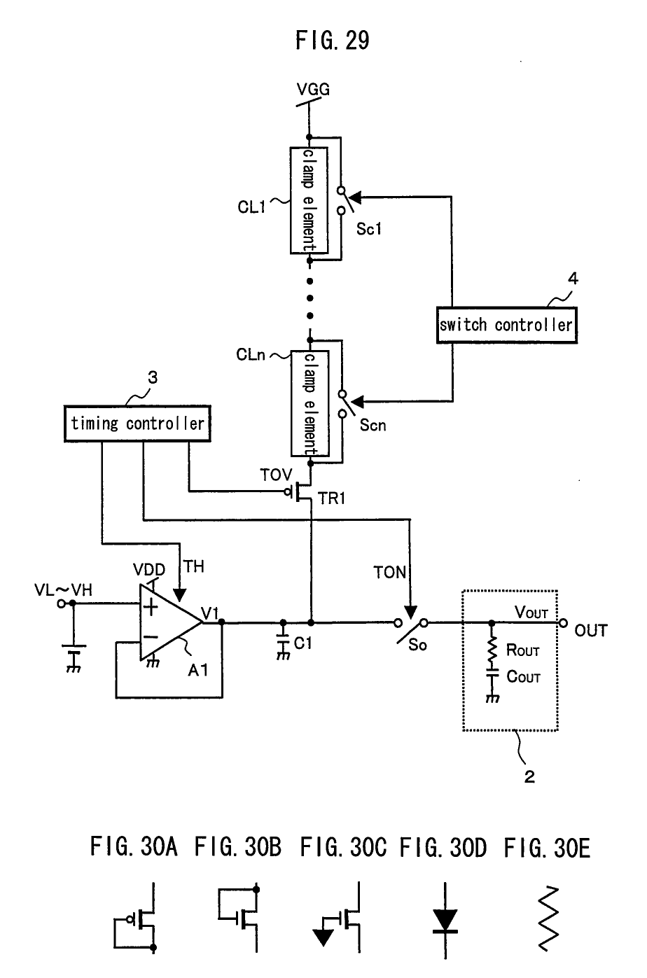

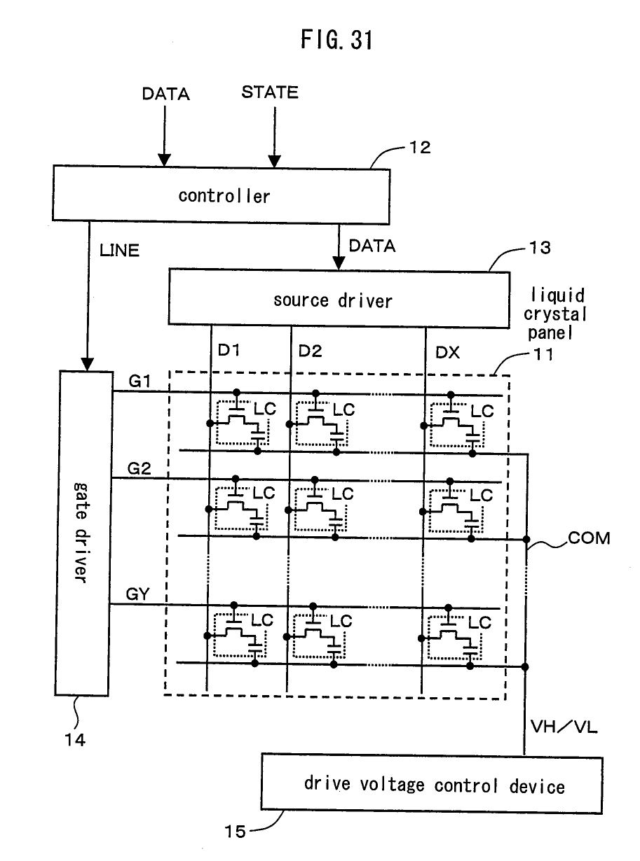

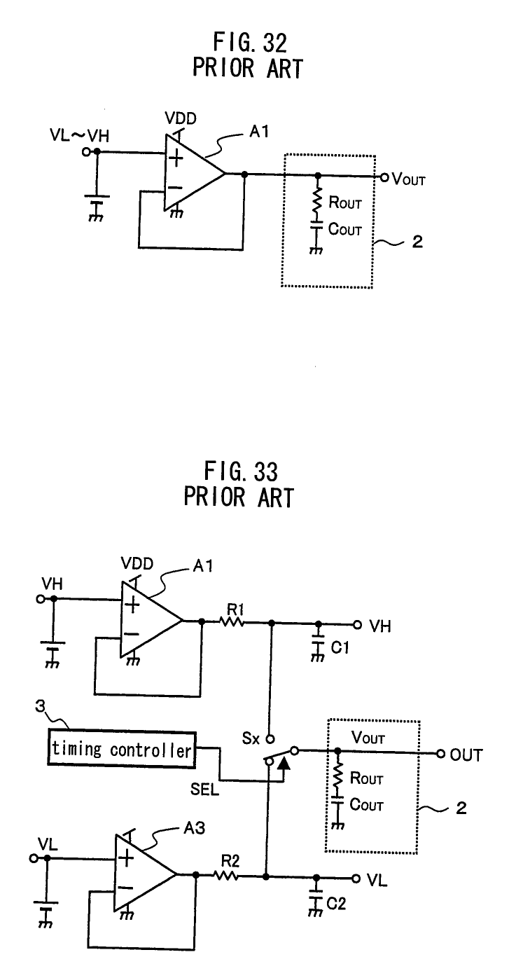

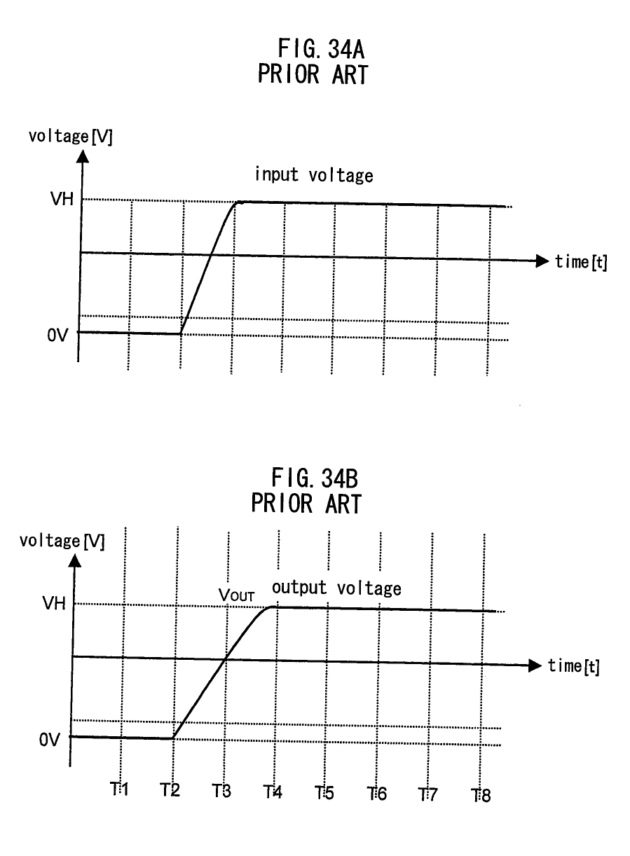

FIG. 29 is a circuit diagram illustrating a constitution of a drive voltage control device for a liquid crystal panel according to a modified embodiment 3 of the preferred embodiment 15. In the modified embodiment, the timing control switch St shown in FIG. 26 is omitted, and the operation amplifier A1 has a high-impedance function instead. As a result, not only the impedance of the output of the drive voltage control device can be reduced, but also the power consumption can be reduced by a power-off function which may be also provided.

FIGS. 30A-30E show a specific example of the clamp element. FIG. 30A shows an example of the clamp element comprising a diode-connected Pch transistor. FIG. 30B shows an example of the clamp element comprising a diode-connected Nch transistor. FIG. 30C shows an example of the clamp element comprising a transistor biased with respect to a saturation region. FIG. 30D shows an example of the clamp element formed from a diode. FIG. 30E shows an example of the clamp element formed from a resistance. In the case where a plurality of clamp elements are serially connected, these different clamp elements may be combined. In the case where the voltage difference between the boost voltage VGG and the load drive voltage V_{OUT} is large (at least 1V), it is desirable that the transistor and diode be combined, or each of them be singly used so that the clamp effect can be surely exerted. In the case where the voltage difference is small, the resistance does not cause any problem.

A hysteresis comparator may be preferably used as the comparator in order to stabilize the comparing operation. In the preferred embodiments described so far, the MOS transistor is used; however, it is needless to say that a bipolar transistor can be used to realize a similar circuit configuration.

While there has been described what is at present considered to be preferred embodiments of this invention, it will be understood that various modifications may be made therein, and it is intended to cover in the appended claims all such modifications as fall within the true spirit and scope of this invention.

1. A drive voltage control device comprising:
a buffer for generating a load drive voltage by impedance-converting an input signal and outputting the generated load drive voltage to a load circuit; and
an input level controller for controlling a voltage of the input signal to be a boost voltage having a potential higher than a potential of a targeted drive voltage of the load drive voltage during a certain period in an initial stage where the voltage of the input signal is changed and controlling the voltage of the input signal to be the targeted drive voltage during a period other than the certain period in the initial stage of the voltage change.

2. The drive voltage control device as claimed in claim 1, wherein
an absolute value of the boost voltage is at least a voltage value of a power supply voltage of the buffer.

3. The drive voltage control device as claimed in claim 1, wherein
an absolute value of the boost voltage is a voltage value lower than a power supply voltage of the buffer.

4. The drive voltage control device as claimed in claim 1, further comprising:
a comparator for comparing the targeted drive voltage and the load drive voltage; and
a boost voltage controller for reducing the boost voltage when the load drive voltage is higher than the targeted drive voltage according to a result of the comparison by the comparator, retaining the boost voltage when the load drive voltage is equal to the targeted drive voltage, and increasing the boost voltage when the load drive voltage is lower than the targeted drive voltage.

5. The drive voltage control device as claimed in claim 4, wherein
the comparator repeatedly compares the voltages periodically based on a set reference time.

6. The drive voltage control device as claimed in claim 4, wherein
the boost voltage controller memorizes the boost voltage and the comparator halts the operation thereof in a state where a convergence time is not updated and in a state where the load circuit is not changed.

7. A drive voltage control device comprising:
a buffer comprising an output terminal, the buffer generating a load drive voltage by impedance-converting an input signal and outputting the generated load drive voltage to a load circuit from the output terminal;
a boost power supply for generating a boost voltage having a potential higher than a potential of a targeted drive voltage of the load drive voltage;
a voltage-increase control switch inserted between the output terminal and the boost power supply; and
a timing controller, wherein
the timing controller makes the voltage-increase control switch conducted to thereby increase the load drive voltage by the boost voltage and supplies the resulting load drive voltage to the load circuit during a certain period in an initial stage where a voltage of the input signal is changed, and the timing controller further makes the voltage-increase control switch non-conducted and supplies the load drive voltage which is not increased by the boost voltage to the load circuit during the period other than the certain period in the initial stage of the voltage change.

8. A drive voltage control device comprising:
a buffer comprising an output terminal, the buffer generating a load drive voltage by impedance-converting an input signal and outputting the generated load drive voltage to a load circuit from the output terminal;
a boost power supply for generating a boost voltage having a potential higher than a potential of a targeted drive voltage;
an input selection switch for selecting one of a voltage of the input signal and the boost voltage and inputting the selected voltage to the buffer;
a smoothing capacitor inserted between the output terminal and a ground;
an output control switch inserted between the smoothing capacitor and the load circuit; and
a timing controller, wherein
the timing controller controls the output control switch to thereby make the smoothing capacitor a charging state and further controls the input selection switch to thereby make the buffer output the boost voltage during a certain period in an initial stage where the voltage of the input signal is changed, and the timing controller controls the output control switch to thereby make the smoothing capacitor a discharging state and further controls the input selection switch to thereby make the buffer output the input signal during the period other than the certain period in the initial stage of the voltage change.

9. A drive voltage control device comprising:
a first buffer for generating a load drive voltage to be supplied to a load circuit by impedance-converting an input signal;
a second buffer for generating a boost voltage having a potential higher than a potential of a targeted drive voltage of the load drive voltage;
an output selection switch comprising an output terminal, the output selection switch selecting one of outputs of the first and second buffers and outputting the selected output from the output terminal to the load circuit;
a smoothing capacitor inserted between the output terminal and a ground;
an output control switch inserted between the smoothing capacitor and the load circuit; and
a timing controller, wherein
the timing controller controls the output control switch to thereby make the smoothing capacitor a charging state and sets the output selection switch so as to select the output of the second buffer during a certain period in an initial stage where a voltage of the input signal is changed, and the timing controller further controls the output control switch to thereby make the smoothing capacitor a discharging state and sets the output selection switch so as to select the output of the first buffer during the period other than the certain period in the initial stage of the voltage change.

10. The drive voltage control device as claimed in claim 9, wherein
the timing controller halts the operation of the second buffer when the output selection switch is set so that the output of the first buffer is selected, and halts the operation of the first buffer when the output selection switch is set so that the output of the second buffer is selected.

11. A drive voltage control device comprising:
a first buffer comprising a first output terminal, the first buffer generating a load drive voltage to be supplied to a load circuit by impedance-converting an input signal and outputting the generated load drive voltage from the first output terminal;
a second buffer comprising a second output terminal, the second buffer generating a boost voltage having a potential higher than a potential of a targeted drive voltage of the load drive voltage and outputting the generated boost voltage from the second output terminal;
a smoothing capacitor inserted between a connecting point between the first and second output terminals, and a ground;
an output control switch inserted between the smoothing capacitor and the load circuit; and
a timing controller, wherein
the timing controller controls the output control switch to thereby make the smoothing capacitor a charging state and sets the first buffer to a operation-halt state and the second buffer to an operable state during a certain period in an initial stage where a voltage of the input signal is changed, and the timing controller further controls the output control switch to thereby make the smoothing capacitor a discharging state and sets the first buffer to the operable state and the second buffer to the operation-halt state during the period other than the certain period in the initial stage of the voltage change.

12. A drive voltage control device according to the present invention comprising:
a buffer comprising an output terminal, the buffer generating a load drive voltage by impedance-converting an input signal and outputting the generated load drive voltage from the output terminal to a load circuit;
a boost power supply for generating a boost voltage having a potential higher than a potential of a targeted drive voltage of the load drive voltage;
a timing control switch and an output control switch serially inserted between the output terminal and the load circuit;
a voltage-increase control switch inserted between a connecting point between the timing control switch and the output control switch, and the boost power supply;
a smoothing capacitor inserted between the connecting point between the timing control switch and the output control switch, and a ground; and
a timing controller, wherein
the timing controller switches off the timing control switch and switches on the output control switch and controls the voltage-increase control switch to be ON during a certain period in an initial stage where a voltage of the input signal is changed, and then, the timing controller switches off the voltage-increase control switch and thereafter switches on the timing control switch.

13. A drive voltage control device comprising:
a buffer comprising an output terminal, the buffer generating a load drive voltage by impedance-converting an input signal and outputting the generated load drive voltage from the output terminal to a load circuit;
a boost power supply for generating a boost voltage having a potential higher than a potential of a targeted drive voltage of the load drive voltage;
a smoothing capacitor inserted between the output terminal and a ground;
a voltage-increase control switch inserted between the output terminal and the boost power supply;
an output control switch inserted between the smoothing capacitor and the load circuit; and
a timing controller, wherein
the timing controller switches off the output control switch and switches on the voltage-increase control switch, and then, sets the output of the buffer to a high-impedance state during a certain period in an initial stage where a voltage of the input signal is changed, and the timing controller further switches on the output control switch and switches off the voltage-increase control switch, and then, releases the buffer from the high-impedance state so that the buffer is operable during the period other than the certain period in the initial stage of the voltage change.

14. A drive voltage control device comprising:
a buffer comprising an inversion input terminal and an output terminal, the buffer generating a load drive voltage by impedance-converting an input signal and outputting the generated load drive voltage from the output terminal to a load circuit;
a smoothing capacitor inserted between the output terminal and a ground;
a feedback control switch for controlling feedback of the buffer by switching between a state where the inversion input terminal is short-circuited with respect to the ground and a state where the inversion output terminal is short-circuited with respect to the output terminal;
an output control switch inserted between the smoothing capacitor and the load circuit; and
a timing controller for switching on and off the output control switch, wherein
the timing controller controls the feedback control switch so that the inversion input terminal is short-circuited with respect to the ground when the output control switch is in the OFF state to thereby make the buffer operate as a comparator and output a power-supply voltage level during a certain period, and the timing controller further controls the feedback control switch so that the inversion input terminal is short-circuited with respect to the output terminal when the output control switch is in the ON state to thereby make the buffer operate as a voltage follower.

15. A drive voltage control device comprising:
a buffer comprising an output terminal, the buffer generating a load drive voltage by impedance-converting an input signal and outputting the generated load drive voltage from the output terminal to a load circuit;
a boost power supply for generating a boost voltage having a potential higher than a potential of a targeted drive voltage of the load drive voltage;
a smoothing capacitor inserted between the output terminal and a ground;
an output control switch inserted between the smoothing capacitor and the load circuit;
a voltage-increase control switch inserted between a connecting point between the output control switch and the load circuit, and the boost power supply;
a comparator; and
a timing controller for timing-controlling the output control switch, wherein
the comparator controls the voltage-increase control switch to be ON when a monitored potential set at the connecting point between the output control switch and the load circuit is below a predetermined reference voltage, and controls the voltage-increase control switch to be OFF when the monitored potential is at least the predetermined reference voltage.

16. A drive voltage control device comprising:
a positive-electrode-side buffer comprising a positive-electrode-side output terminal, the buffer generating a positive-electrode-side load drive voltage by impedance-converting a positive-electrode-side input signal and outputting the generated positive-electrode-side load drive voltage from the positive-electrode-side output terminal to a load circuit;
a positive-electrode-side boost power supply for generating a positive-electrode-side boost voltage higher than the positive-electrode-side load drive voltage;
a positive-electrode-side input selection switch for selecting one of a voltage of the positive-electrode-side input signal and the positive-electrode-side boost voltage and inputting the selected voltage to the positive-electrode-side buffer;
a positive-electrode-side smoothing capacitor inserted between the positive-electrode-side output terminal and a ground;
a negative-electrode-side buffer comprising a negative-electrode-side output terminal, the buffer generating a negative-electrode-side load drive voltage by impedance-converting a negative-electrode-side input signal and outputting the generated negative-electrode-side load drive voltage from the negative-electrode-side output terminal to the load circuit;
a negative-electrode-side boost power supply for generating a negative-electrode-side boost voltage lower than the negative-electrode-side load drive voltage;
a negative-electrode-side input selection switch for selecting one of a voltage of the negative-electrode-side input signal and the negative-electrode-side boost voltage and inputting the selected voltage to the negative-electrode-side buffer;
a negative-electrode-side smoothing capacitor inserted between the negative-electrode-side output terminal and the ground;
an output switch for alternately switching between the output of the positive-electrode-side buffer and the output of the negative-electrode-side buffer; and
a timing controller for switching between the output of the positive-electrode-side buffer and the output of the negative-electrode-side buffer and outputting the selected output to the load circuit, wherein
in the state where the output switch is controlled to select the output of positive-electrode-side buffer, the timing controller controls the positive-electrode-side input selection switch so that the positive-electrode-side input signal is inputted to the positive-electrode-side buffer and controls the negative-electrode-side input selection switch so that the negative-electrode-side boost voltage is inputted to the negative-electrode-side buffer, and, in the state where the output switch is controlled to select the output of negative-electrode-side buffer, the timing controller further controls the negative-electrode-side input selection switch so that the negative-electrode-side input signal is inputted to the negative-electrode-side buffer and controls the positive-electrode-side input selection switch so that the positive-electrode-side boost voltage is inputted to the positive-electrode-side buffer.

17. A drive voltage control device comprising:
a positive-electrode-side buffer comprising a positive-electrode-side output terminal, the buffer generating a positive-electrode-side load drive voltage by impedance-converting a positive-electrode-side input signal and outputting the generated positive-electrode-side load drive voltage from the positive-electrode-side output terminal to a load circuit;
a positive-electrode-side boost power supply for generating a positive-electrode-side boost voltage higher than the positive-electrode-side load drive voltage;
a positive-electrode-side smoothing capacitor inserted between the output terminal of the positive-electrode-side buffer and a ground;
a positive-electrode-side voltage-increase control switch inserted between the positive-electrode-side output terminal and the positive-electrode-side boost power supply;
a negative-electrode-side buffer comprising a negative-electrode-side output terminal, the buffer generating a negative-electrode-side load drive voltage by impedance-converting a negative-electrode-side input signal and outputting the generated negative-electrode-side load drive voltage from the negative-electrode-side output terminal to the load circuit;
a negative-electrode-side boost power supply for generating a negative-electrode-side boost voltage lower than the negative-electrode-side load drive voltage;
a negative-electrode-side smoothing capacitor inserted between the negative-electrode-side output terminal and the ground;
a negative-electrode-side voltage-increase control switch inserted between the negative-electrode-side output terminal and the negative-electrode-side boost power supply;
an output switch for alternately switching between the output of the positive-electrode-side buffer and the output of the negative-electrode-side buffer; and
a timing controller for switching between the output of the positive-electrode-side buffer and the output of the negative-electrode-side buffer and outputting the selected output to the load circuit, wherein
the timing controller controls the negative-electrode-side voltage-increase control switch to be ON when the output switch is controlled to select the output of the positive-electrode-side buffer, and controls the positive-electrode-side voltage-increase control switch to be ON when the output switch is controlled to select the output of the negative-electrode-side buffer.

18. A drive voltage control device comprising:
a positive-electrode-side buffer comprising a positive-electrode-side output terminal, the buffer generating a positive-electrode-side load drive voltage by impedance-converting a positive-electrode-side input signal and outputting the generated positive-electrode-side load drive voltage from the positive-electrode-side output terminal to a load circuit;
a positive-electrode-side boost power supply for generating a positive-electrode-side boost voltage higher than the positive-electrode-side load drive voltage;
a positive-electrode-side smoothing capacitor inserted between the positive-electrode-side output terminal and a ground;
a negative-electrode-side buffer comprising a negative-electrode-side output terminal, the buffer generating a negative-electrode-side load drive voltage by impedance-converting a negative-electrode-side input signal and outputting the generated negative-electrode-side load drive voltage from the negative-electrode-side output terminal to the load circuit;
a negative-electrode-side boost power supply for generating a negative-electrode-side boost voltage lower than the negative-electrode-side load drive voltage;
a negative-electrode-side smoothing capacitor inserted between the negative-electrode-side output terminal and the ground;
an output switch comprising an output terminal, the output switch alternately switching between the output of the positive-electrode-side buffer and the output of the negative-electrode-side buffer and outputting the selected output from the output terminal to the load circuit;
a timing controller for timing-controlling the output switch;
a positive-electrode-side voltage-increase control switch inserted between the output terminal and the positive-electrode-side boost power supply;
a positive-electrode-side comparator for controlling the positive-electrode-side voltage-increase control switch to be ON when a potential of the positive-electrode-side smoothing capacitor is below a predetermined reference voltage, and controlling the positive-electrode-side voltage-increase control switch to be OFF when the potential of the positive-electrode-side smoothing capacitor is at least the predetermined reference voltage;
a negative-electrode-side voltage-increase control switch inserted between the output terminal and the negative-electrode-side boost power supply; and
a negative-electrode-side comparator for controlling the negative-electrode-side voltage-increase control switch to be ON when a potential of the negative-electrode-side smoothing capacitor is over a predetermined reference voltage, and controlling the negative-electrode-side voltage-increase control switch to be OFF when the potential of the negative-electrode-side smoothing capacitor is at most the predetermined reference voltage.

19. A drive voltage control device comprising:
a positive-electrode-side buffer comprising a positive-electrode-side output terminal, the buffer generating a positive-electrode-side load drive voltage by impedance-converting a positive-electrode-side input signal and outputting the generated positive-electrode-side load drive voltage from the positive-electrode-side output terminal to a load circuit;
a positive-electrode-side boost power supply for generating a positive-electrode-side boost voltage higher than the positive-electrode-side load drive voltage;
a positive-electrode-side smoothing capacitor inserted between the positive-electrode-side output terminal of the positive-electrode-side buffer and a ground;
a negative-electrode-side buffer comprising a negative-electrode-side output terminal, the buffer generating a negative-electrode-side load drive voltage by impedance-converting a negative-electrode-side input signal and outputting the generated negative-electrode-side load drive voltage from the negative-electrode-side output terminal to the load circuit;
a negative-electrode-side boost power supply for generating a negative-electrode-side boost voltage lower than the negative-electrode-side load drive voltage;
a negative-electrode-side smoothing capacitor inserted between the negative-electrode-side output terminal and the ground;
an output switch comprising an output terminal, the output switch alternately switching between the output of the positive-electrode-side buffer and the output of the negative-electrode-side buffer and outputting the selected output from the output terminal to the load circuit;
a positive-electrode-side voltage-increase control switch inserted between the output terminal and the positive-electrode-side boost power supply;
a negative-electrode-side voltage-increase control switch inserted between the output terminal and the negative-electrode-side boost power supply;
a comparator comprising an inversion input terminal and a non-inversion input terminal, the comparator monitoring a potential of the positive-electrode-side smoothing capacitor and a potential of the negative-electrode-side smoothing capacitor;
a timing controller; and
a group of reference potential switches operating in a manner contrary to one another, wherein
the inversion input terminal is connected to a positive-electrode-side reference potential and a negative-electrode-side reference potential via the group of reference potential switches,
the non-inversion input terminal is connected to the output terminal,
in a state where the positive-electrode-side reference potential is inputted to the inversion input terminal via the group of reference potential switches, the comparator controls the positive-electrode-side voltage-increase control switch to be ON when a first applied voltage inputted to the comparator is below the positive-electrode-side reference voltage, and controls the positive-electrode-side voltage-increase control switch to be OFF when the first applied voltage is at least the reference voltage, and, in a state where the negative-electrode-side reference potential is inputted to the inversion input terminal via the group of reference potential switches, the comparator further controls the negative-electrode-side voltage-increase control switch to be ON when a second applied voltage inputted to the comparator is over the negative-electrode-side reference voltage, and controls the negative-electrode-side voltage-increase control switch to be OFF when the second applied voltage is at most the reference voltage, and
the timing controller timing-controls the output switch and the group of reference potential switches.

20. The drive voltage control device as claimed in claim 7, wherein
a low-breakdown-voltage transistor constitutes the voltage-increase control switch, wherein
a clamp element for voltage drop is inserted between the voltage-increase control switch and the boost power supply.

21. The drive voltage control device as claimed in claim 12, wherein
a low-breakdown-voltage transistor constitutes the voltage-increase control switch, wherein
a clamp element for voltage drop is inserted between the voltage-increase control switch and the boost power supply.

22. The drive voltage control device as claimed in claim 13, wherein
a low-breakdown-voltage transistor constitutes the voltage-increase control switch, wherein
a clamp element for voltage drop is inserted between the voltage-increase control switch and the boost power supply.

23. The drive voltage control device as claimed in claim 15, wherein
a low-breakdown-voltage transistor constitutes the voltage-increase control switch, wherein
a clamp element for voltage drop is inserted between the voltage-increase control switch and the boost power supply.

24. The drive voltage control device as claimed in claim 17, wherein
a low-breakdown-voltage transistor constitutes each of the positive-electrode-side voltage-increase control switch and the negative-electrode-side voltage-increase control switch, wherein
a clamp element for voltage drop is inserted between the positive-electrode-side voltage-increase control switch and the positive-electrode-side boost power supply, and also between the negative-electrode-side voltage-increase control switch and the negative-electrode-side boost power supply.

25. The drive voltage control device as claimed in claim 18, wherein
a low-breakdown-voltage transistor constitutes each of the positive-electrode-side voltage-increase control switch and the negative-electrode-side voltage-increase control switch, wherein
a clamp element for voltage drop is inserted between the positive-electrode-side voltage-increase control switch and the positive-electrode-side boost power supply, and also between the negative-electrode-side voltage-increase control switch and the negative-electrode-side boost power supply.

26. The drive voltage control device as claimed in claim 19, wherein
a low-breakdown-voltage transistor constitutes each of the positive-electrode-side voltage-increase control switch and the negative-electrode-side voltage-increase control switch, wherein
a clamp element for voltage drop is inserted between the positive-electrode-side voltage-increase control switch and the positive-electrode-side boost power supply, and also between the negative-electrode-side voltage-increase control switch and the negative-electrode-side boost power supply.

27. The drive voltage control device as claimed in claim 20, further comprising a switch controller, wherein
the clamp element is a plurality of clamp elements serially connected to each other, and a short-circuit switching element is connected in parallel to each of the plurality of clamp elements, and
the switch controller arbitrarily switches on and off the short-circuit switching elements.

28. The drive voltage control device as claimed in claim 21, further comprising a switch controller, wherein
the clamp element is a plurality of clamp elements serially connected to each other, and a short-circuit switching element is connected in parallel to each of the plurality of clamp elements, and
the switch controller arbitrarily switches on and off the short-circuit switching elements.

29. The drive voltage control device as claimed in claim 22, further comprising a switch controller, wherein
the clamp element is a plurality of clamp elements serially connected to each other, and a short-circuit switching element is connected in parallel to each of the plurality of clamp elements, and
the switch controller arbitrarily switches on and off the short-circuit switching elements.

30. The drive voltage control device as claimed in claim 23, further comprising a switch controller, wherein
the clamp element is a plurality of clamp elements serially connected to each other, and a short-circuit switching element is connected in parallel to each of the plurality of clamp elements, and
the switch controller arbitrarily switches on and off the short-circuit switching elements.

31. The drive voltage control device as claimed in claim 24, further comprising a switch controller, wherein
the clamp element is a plurality of clamp elements serially connected to each other, and a short-circuit switching element is connected in parallel to each of the plurality of clamp elements, and
the switch controller arbitrarily switches on and off the short-circuit switching elements.

32. The drive voltage control device as claimed in claim 25, further comprising a switch controller, wherein
the clamp element is a plurality of clamp elements serially connected to each other, and a short-circuit switching element is connected in parallel to each of the plurality of clamp elements, and
the switch controller arbitrarily switches on and off the short-circuit switching elements.

33. The drive voltage control device as claimed in claim 26, further comprising a switch controller, wherein
the clamp element is a plurality of clamp elements serially connected to each other, and a short-circuit switching element is connected in parallel to each of the plurality of clamp elements, and
the switch controller arbitrarily switches on and off the short-circuit switching elements.
